(19) United States
(12) Patent Application Publication
(10) Pub. No.: US 2020/0086757 A1
(43) Pub. Date: Mar. 19, 2020

(54) DEVICE AND SYSTEM FOR INCREASING TOLERANCE IN A BATTERY STATION

(71) Applicant: STARSHIP TECHNOLOGIES OÜ, Tallinn (EE)

(72) Inventors: Lauri VÄIN, Tallinn (EE); Viljar VALDEK, Tallinn (EE); Märt LIIVIK, Tallinn (EE); Henri LEND, Tallinn (EE); Sergii KHARAGORGIIEV, Tallinn (EE); Markus JÄRVE, Tallinn (EE); Henrik HERRANEN, Tallinn (EE); Ahti HEINLA, Tallinn (EE); Veigo EVARD, Tallinn (EE); Tommy BIENE, Tallinn (EE)

(21) Appl. No.: 16/690,897

(22) Filed: Nov. 21, 2019

Related U.S. Application Data
(63) Continuation of application No. PCT/EP2018/063619, filed on May 24, 2018.

(30) Foreign Application Priority Data
May 26, 2017 (EP) 17173124.3

(51) Int. Cl. B60L 53/80; B60S 5/06; F16C 11/12

(52) U.S. Cl. CPC B60L 53/80; B60L 53/30; F16C 11/12; B60S 5/06

(57) ABSTRACT

A flexural joint, preferably for use in a battery station, comprising: a first group of rigid members configured to mount a first group of elements to the flexural joint; a second group of rigid members configured to mount a second group of elements to the flexural joint; a third group of elastic members configured to provide flexibility; a first flexural mechanism configured to allow rotational motion of at least one of the first group of rigid members with respect to the second group of rigid members and the second group of rigid members with respect to the first group of rigid members; and a second flexural mechanism configured to allow linear motion of at least one of the first group of rigid members with respect to the second group of rigid members and second group of rigid members with respect to the first group of rigid members.

### FIELD

The invention relates to the field of mobile robots. More specifically, the invention relates to a battery station for swapping and charging mobile robot batteries. Even more specifically, the invention relates to increasing mechanical fault tolerance in a battery station.

### INTRODUCTION

As technology improves mobile robots are becoming part of people's everyday life. More and more tasks are being automated and accomplished by mobile robots. Further the need for a safer environment is driving the automotive industry into increasing the production of electric vehicles. Thus, the number of mobile robots and electric vehicles is increasing more and more. In order to operate, usually, these mobile robots and electric vehicles require electric energy, in other words a battery. However, after a specific operation time the battery discharges. In most cases the operator of such mobile robots and electric vehicles will remove the battery himself and put it for charging in a power station. In another case, the operator may swap the discharged battery with an already charged battery. In such cases the operator has to lift the batteries himself Usually such batteries are heavy and may cause damages to the physical health of the operator. Furthermore, if the operator does not have a charged battery he will have to wait until the battery charges which interrupts the operation of the mobile robot or electric vehicle.

U.S. Pat. No. 5,545,967 describes a system for automatic loading, unloading and charging of rechargeable batteries used in battery powered vehicles. The system comprises a storage rack for temporary storing batteries. It further comprises one battery recharging station. A battery transport apparatus swaps the discharged battery of the vehicle with a charged one. The system further comprises a water check station that checks the water level of the batteries.

U.S. Pat. No. 5,998,963 describes a service center for replacing and recharging an electric battery from electric vehicles. The system comprises a recharging unit for charging the batteries removed from an electric vehicle. An electric vehicle is driven into a bay where a removing-installation means removes the discharged battery from the vehicle. A transporting means transport the battery from the removal installation means to the recharging unit. The said transporting means can also transport a battery from a recharging unit to the removal-installation means. The removal-installation means can install the battery in the vehicle.

It is often advantageous that particular elements of battery stations be coupled in a flexible manner Furthermore, it may be required that the coupling between elements have pre-determined flexibility, that is, the elements should be preferably coupled in such a way that they have degrees of freedom only in pre-determined and intended directions. It may also be advantageous if coupling between elements is associated with constraints in the degrees of freedom other than the intended ones. A battery station can comprise a plurality of devices that are configured to grab the battery of the mobile robot. To facilitate the grabbing of the battery, it can be advantageous if certain parts of the battery station that grab the battery of the mobile robot are connected with the rest of the battery station through flexural joints. Such flexural joints allow certain motion only on pre-determined degrees of freedom. It can be advantageous if such flexural joints allow more than one degree of freedom.

Different flexural joint designs exist in the state of the art. Common flexure designs are the pin flexure, the blade flexure, the notch flexure, a living hinge flexure, etc.

The present invention relates to a flexural joint that is configured to increase fault tolerance of a battery swapping and charging station. The flexural joint disclosed herein is configured to provide two degrees of freedom, a rotational one and a substantially linear one. The current invention also relates to a system comprising a flexural joint and a battery station for grabbing and swapping a battery of a mobile robot.

### SUMMARY

In a first embodiment, the invention describes a flexural joint, preferably for use in a battery station. The flexural joint comprises a first group of rigid members configured to mount a first group of elements to the flexural joint. The flexural joint further comprises a second group of rigid members configured to mount a second group of elements to the flexural joint. The flexural joint also comprises a third group of elastic members configured to provide flexibility. The flexural joint also comprises a first flexural mechanism configured to allow rotational motion of at least one of the first group of rigid members with respect to the second group of rigid members and the second group of rigid members with respect to the first group of rigid members. The flexural joint further comprises a second flexural mechanism configured to allow linear motion of at least one of the first group of rigid members with respect to the second group of rigid members and second group of rigid members with respect to the first group of rigid members.

That is, the flexural joint can be configured to allow motion or displacement along two distinct degrees of freedom: a translational one and a rotational one. This can be particularly advantageous when using the flexural joint for increasing the alignment tolerances of a mechanical system. Preferably, such system can be a battery swapping station. The battery swapping station can be used to autonomously, semi-autonomously and/or non-autonomously to swap a battery of a mobile robot. The battery can be placed in a mobile robot in such a way, that autonomous or semi-autonomous swapping is facilitated. That is, the battery can be placed in a location easily accessed by a mechanical automated swapping system. For example, the battery can be accessible from the bottom, top, or from the sides of a mobile robot. The battery station can comprise one of a plurality of battery charging slots, which can be used to charge empty batteries, store the full batteries ready to be loaded onto a mobile robot, or store defective batteries until maintenance can be provided. The flexural joint can be used as part of a battery swapping station to provide increased flexibility to the mechanical components grabbing the battery. The flexural joint can facilitate the aligning of such components with the battery (that is, preferably, with the robot comprising the battery) and assure that the battery can be grabbed even if slight misalignment occurs for some reason. In such embodiments, the flexural joint can be used instead of a spring or a system of springs that can be more difficult to manufacture, configure and maintain.

In some embodiments, the flexural joint can be configured to allow motion with at least two degrees of freedom. In such embodiments, a first degree of freedom can allow rotational motion of the first group of rigid members with respect to the second group of rigid members and/or the second group of rigid members with respect to the first group of rigid members. That is, one part of the flexural joint can rotate with respect to another part. Depending on how the flexural joint is fixed to the battery station, this can provide rotational flexibility in a certain direction. A second degree of freedom can allow at least substantially linear motion of the first group of rigid members with respect to the second group of rigid members in the direction perpendicular to an axis connecting the first group of rigid members and the second group of rigid members. The second degree of freedom can also allow at least substantially linear motion of the second group of rigid members with respect to the first group of rigid members in the direction perpendicular to an axis connecting the first group of rigid members and the second group of rigid members. The direction of linear motion can also be described as substantially vertical when the flexural joint is oriented in its standard direction of operation. That is, in embodiments where the flexural joint is part of a battery swapping station, it comprises a standard orientation direction in which it is used as part of the station. With respect to this direction, the linear motion can be defined as substantially vertical. The axis connecting the first and second groups of rigid members need not be literal, and can rather be viewed as a construct to facilitate the specification of the direction. That is, in such embodiments, the flexural joint can allow the system that it is attached to, to comprise flexibility in the vertical alignment of the mechanical components.

In some embodiments, the motion with at least two degrees of freedom can be facilitated by thin elastic members of the flexural joint that bend at predefined distances and/or predictable trajectories. That is, the flexural joint can comprise members of varying thickness resulting in different flexibilities along different axes of motion. The thin elastic members can be advantageous, as they can provide sufficient but not exceeding freedom of motion in order to facilitate the alignment of the system elements. The thin elastic members can comprise part of one integral piece of the flexural joint, differing from the other members in thickness. This can be advantageous, as the integrity of the flexural joint as a whole can be easier maintained and a greater durability ensured.

In some embodiments, the flexural joint can comprise a higher stiffness in the degrees of freedom other than the at least two degrees of freedom intended to provide flexibility according to a preceding embodiment. That can be particularly beneficial in system where the flexural joint can be used to increase tolerances in possible errors in mechanical alignment. It can be advantageous that the flexural joint only allows flexibility and therefore motion in certain directions via certain axes of motion and not others. For example, in embodiments where the flexural joint can be used as part of a battery swapping station, as a means to provide increased tolerance to the grippers that swap the battery, it can be advantageous for the flexural joint to allow the grippers to incline in one direction or another, to rotate together, but not to twist in a way that would change the distance between the grippers, and prevent grabbing of the battery by the grippers.

In some embodiments, the flexural joint can be monolithic i.e. the flexural joint can comprise a monolithic structure. That is, the flexural joint can be composed of a single cohesive piece, i.e. the flexural joint consists of one piece. Note, that when referring to different groups of members of the flexural joint or the connection between such groups of members, it does not mean that such groups of members or members are composed of several interconnected parts that are joined together. Rather, the different members and groups of members are referred to as such to separate their functions and applications. The flexural joint can comprise a single material, a composite material or can be a mixture of single and composite materials. In a preferred embodiment, the flexural joint can comprise a plastic material. More preferably, it can be a plastic material that can facilitate the use of at least one of 3D printing technology, injection molding and extrusion for manufacturing the flexural joint. Manufacturing the flexural joint in one piece is very advantageous, as it allows the part to be produced at once without requiring assembly. Furthermore, the possibility to manufacture it via 3D printing or injection molding or extrusion technology can make it easier to produce the exact desired shape of a high quality and durability. Using plastic can be advantageous, as thinner parts of the flexural joint can be flexible, while thicker ones rigid or stiff as described above and below.

In some embodiments, the flexural joint can comprise a combination of at least one first flexural mechanism and at least one second flexural mechanism. For example, the flexural joint can comprise a plurality of second flexural mechanisms, such as two second flexural mechanisms arranged on each side of the first flexural mechanism. This can ensure stability of the flexural joint and provide a consistent vertical flexibility of each of the flanks, with the center being rotationally flexible.

In some embodiments, at least one of the first group of rigid members and the second group of rigid members of the flexural joint can comprise a thicker thickness than the third group of elastic members of the flexural joint. Such an arrangement can be configured to provide at least one of motion with at least 2 degrees of freedom and high stiffness in all other degrees of freedom except the at least 2 degrees of freedom intended to provide motion. For example, the thinner flexible members of the flexural joint can comprise a minimum thickness in the range of 0.1 to 2 mm, such 0.1 to 0.5 mm and the thicker stiff members can comprise a maximum thickness of 1 to 10 mm, such as 1 to 5 mm.

In some embodiments, the first group of rigid members can comprise at least one of the following elements: a mounting base, a top surface.

In some embodiments, the second group of rigid members can comprise any of the following elements: a first mounting side, a second mounting side.

In some embodiments, the third group of elastic members can comprise any of the following elements: an elastic elongated element, a first elastic arm, a second elastic arm.

In some embodiments, the first flexural mechanism can comprise a mounting base connected with a top surface by two elastic elongated elements with each of the elastic elongated elements having one end attached to the top surface and the other end attached to the mounting base, and wherein the two elastic elongated elements are intersected at a pivot point, forming an “X”-like structure. Such a structure can be particularly robust and flexible. The pivot point of the X can provide increased stability, and the arms can ensure the robustness of the structure. In some such embodiments, the elastic elongated elements can be configured to allow at least one of the mounting base and the top surface to rotate with respect to an axis parallel to at least one of the mounting base and the top surface, said axis passing through the pivot point. The rotation of at least one of the mounting base and the top surface can be limited to a predefined degree by at least one of a first limiting wall and a second limiting wall. This can be advantageous, as it can avoid excessive rotation leading to damage to the flexural joint and/or to the system.

In some embodiments, the first flexural mechanism can be configured to provide rotation flexibility of 0.2 to 15 degrees, more preferably 0.5 to 10 degrees, even more preferably 0.5 to 5 degrees clockwise and/or counterclockwise. This range can be particularly advantageous to ensure sufficient tolerance in the alignment of the system (such as the alignment of the grippers reaching for the battery), while preventing excessive rotation potentially leading to system damage or failure.

In some embodiments, the first flexural mechanism can be configured as a cartwheel hinge.

In some embodiments, the second flexural mechanism can comprise a first mounting side connected with a second mounting side by at least one of a first elastic arm and a second elastic arm. The first elastic arm and/or the second elastic arm can be attached on one end to the first mounting side and on the other end to the second mounting side. At least one of the first elastic arm and the second elastic arm can allow the first mounting side to move substantially linearly in the direction perpendicular to the surface of the first elastic arm with respect to the fixed second mounting side. At least one of the first elastic arm and the second elastic arm can also allow the second mounting side to move substantially linearly in the direction perpendicular to the surface of the second elastic arm with respect to the fixed first mounting side. The direction of substantially linear motion can also be described as “vertical” when the flexural joint is oriented as it is intended to operate (for example, when mounted as part of a battery swapping station). In such a way, the flexible or elastic arms can be connected to the rigid or stiff sides, ensuring flexibility in the desired direction only. Note, that the word “attached” can refer simply to being connected with. As the flexural joint can comprise a monolithic component, “attached” need not refer to something connected together by methods other than the integrity of a single piece of material.

In some embodiments, the second flexural mechanism can be configured to provide linear flexibility of 0.5 to 15 mm, preferably 1 to 10 mm, even more preferably 1 to 5 mm up and/or down from the equilibrium. That is, the second flexural mechanism can allow the flexural joint to allow motion of this range in either the vertical or horizontal direction. Again, this range can be advantageous for providing increased tolerance to misalignments to the system. A smaller range can be insufficient to correct for misalignments, and a larger range might mean greater flexibility (that is, a smaller effective spring constant) and potentially insufficient stiffness in the system.

In some embodiments, the second flexural mechanism can be configured as a parallelogram flexure.

In a second embodiment, the invention discloses a system for swapping a battery. The system comprises at least one flexural joint in accordance with any of the embodiments described above. The system further comprises a battery station configured to swap a battery.

In some embodiments, the flexural joint is configured to facilitate the battery swapping by the battery station. That is, the flexural joint can increase tolerance to misalignment within the system and ensure greater flexibility during battery swapping.

In some embodiments, the flexural joint can be configured to increase the tolerable misalignment for grabbing the battery, between the battery station and the battery. The tolerable misalignment can the maximum incorrect positioning of the battery relative to the battery station, such that the battery station is able to grab the battery. The tolerable misalignment can also comprise the maximum incorrect positioning of the battery station relative to the battery, such that the battery station is able to grab the battery.

In some embodiments, the battery station can comprise a battery grabber element adapted to grab a battery. The battery grabber element can comprise a plurality of grippers attached to the battery grabber element using at least one flexural joint. In such embodiments, the flexural joint can be adapted to provide increased flexibility to the grippers, so that even when the grippers and/or the battery are slightly misaligned with each other, the system can self-correct and ensure successful grabbing of the battery. In some such embodiments, the flexural joint can comprise a first group of rigid members, configured to mount the flexural joint on the battery grabber element. The first group of rigid members can comprise at least one of the following elements: a mounting base and a top surface. The flexural joint can also comprise a second group of rigid members, configured to mount the grippers to the flexural joint. The second group of rigid members can comprise at least one of the following elements: a first mounting side and a second mounting side.

In some embodiments, the flexural joint is adapted to increase the tolerance of the battery station by at least 1 mm, preferably at least 2 mm, more preferably at least 3 mm by providing flexibility to the system. That is, the use of the flexural joint in a system can ensure than even when the battery station (or, preferably, the grippers of the battery station) and the battery are misaligned by a distance in the above range, the battery can still be grabbed by the station (or, preferably, by the grippers).

In some embodiments, the flexural joint can be configured to elastically deform along at least two degrees of freedom. As described above, this is particularly beneficial to provide flexibility in a plurality of directions to ensure an increased tolerance within the system.

In some embodiments, the grippers can be configured to grip the battery at least with the tolerance provided by the flexural joint. That is, the grippers of the battery station can successfully grip the battery even in the case of misalignment between the grippers and the battery, as long as this misalignment does not exceed the maximum correction ensured by the flexural joint. This maximum correction can be as given above, that is, at least 1 mm, more preferably at least 2 mm, even more preferably at least 3 mm.

Below, further numbered embodiments of the invention will be discussed.

### Device Embodiments

D1. A flexural joint (360), preferably for use in a battery station (10), comprising:
   a) a first group of rigid members (374, 378) configured to mount a first group of elements to the flexural joint (360);
   b) a second group of rigid members (382, 384) configured to mount a second group of elements to the flexural joint (360);
   c) a third group of elastic members (372, 386, 388) configured to provide flexibility;
   d) a first flexural mechanism (370) configured to allow rotational motion of at least one of the first group of rigid members (374, 378) with respect to the second group of rigid members (382, 384) and the second group of rigid members (382, 384) with respect to the first group of rigid members (374, 378);
   e) a second flexural mechanism (380) configured to allow linear motion of at least one of the first group of rigid members (374, 378) with respect to the second group of rigid members (382, 384) and second group of rigid members (382, 384) with respect to the first group of rigid members (374, 378).

### Kinematic Characteristics

D2. A flexural joint (360) in accordance with the preceding embodiment, wherein the flexural joint (360) is configured to allow motion with at least two degrees of freedom (2-DOF) wherein
   a) a first degree of freedom allows rotational motion of at least one of
      i. the first group of rigid members (374, 378) with respect to the second group of rigid members (382, 384); and
      ii. the second group of rigid members (382, 384) with respect to the first group of rigid members (374, 378), and
   b) a second degree of freedom allows at least substantially linear motion of at least one of
      i. the first group of rigid members (374, 378) with respect to the second group of rigid members (382, 384) in the direction perpendicular to an axis connecting the first group of rigid members (374, 378) and the second group of rigid members (382, 284); and
      ii. the second group of rigid members (382, 384) with respect to the first group of rigid members (374, 378) in the direction perpendicular to an axis connecting the first group of rigid members (374, 378) and the second group of rigid members (382, 284).
D3. A flexural joint (360) in accordance with the preceding embodiment, wherein the motion with at least two degrees of freedom is facilitated by thin elastic members of the flexural joint (360) that bend at predefined distances and/or predictable trajectories.
D4. A flexural joint (360) in accordance with any of the preceding embodiments and with the features of embodiment D2, wherein the flexural joint (360) comprises a higher stiffness in the degrees of freedom other than the at least two degrees of freedom intended to provide flexibility according to embodiment D2.

### Manufacturing Characteristics

D5. A flexural joint (360) in accordance with any of the preceding embodiments, wherein the flexural joint (360) is monolithic and preferably comprises a plastic material, more preferably a plastic material that facilitates the use of at least one of 3D printing technology, injection molding, and extrusion for manufacturing the flexural joint (360).
D6. A flexural joint (360) in accordance with any of the preceding embodiments, wherein the flexural joint (360) comprises a combination of at least one first flexural mechanism (370) and at least one second flexural mechanism (380).
D7. A flexural joint (360) in accordance with any of the preceding embodiments and with the features of embodiment D2, wherein at least one of the first group of rigid members (374, 378) and the second group of rigid members (382, 384) of the flexural joint (360) comprise a thicker thickness than the third group of elastic members (372, 386, 388) of the flexural joint (360), configured to provide at least one of flexibility with at least 2 degrees of freedom and high stiffness in all other degrees of freedom except the at least 2 degrees of freedom intended to provide flexibility.

### Group Members

D8. A flexural joint (360) in accordance with any of the preceding embodiments, wherein the first group of rigid members (374, 378) comprises at least one of the following elements:
   a) a mounting base (374),
   b) a top surface (378).
D9. A flexural joint (360) in accordance with any of the preceding embodiments, wherein the second group of rigid members (382, 384) comprises any of the following elements:
   a) a first mounting side (382),
   b) a second mounting side (384).
D10. A flexural joint (360) in accordance with any of the preceding embodiments, wherein the third group of elastic members (372, 386, 388) comprise any of the following elements:
   a) an elastic elongated element (372),
   b) a first elastic arm (386),
   c) a second elastic arm (388).

### First Flexural Mechanisms

D11. A flexural joint (360) in accordance with any of the preceding embodiments, wherein the first flexural mechanism (370) comprises a mounting base (374) connected with a top surface (378) by two elastic elongated elements (372) with each of the elastic elongated elements (372) having one end attached to the top surface (378) and the other end attached to the mounting base (374), and wherein the two elastic elongated elements (372) are intersected at a pivot point (375), forming an “X”-like structure.
D12. A flexural joint (360) in accordance with the preceding embodiment, wherein the elastic elongated elements (372) are configured to allow at least one of the mounting base (374) and the top surface (378) to rotate with respect to an axis parallel to at least one of the mounting base (374) and the top surface (378), said axis passing through the pivot point (375).
D13. A flexural joint (360) in accordance with the preceding embodiment, wherein the rotation of at least one of the mounting base (374) and the top surface (378) is limited to a predefined degree by at least one of a first limiting wall (371) and a second limiting wall (373).
D14. A flexural joint (360) in accordance with any of the preceding embodiments, wherein the first flexural mechanism is configured to provide rotation flexibility of 0.2 to 15 degrees, more preferably 0.5 to 10 degrees, even more preferably 0.5 to 5 degrees clockwise and/or counterclockwise, from the equilibrium.
D15. A flexural joint (360) in accordance with any of the preceding embodiments, wherein the first flexural mechanism (370) is configured as a cartwheel hinge (370).

### Second Flexural Mechanism

D16. A flexural joint (360) in accordance with any of the preceding embodiments, wherein the second flexural mechanism (380) comprises a first mounting side (382) connected with a second mounting side (384) by at least one of a first elastic arm (386) and a second elastic arm (388), wherein the first elastic arm (386) and/or the second elastic arm (388) are attached on one end to the first mounting side (382) and on the other end to the second mounting side (384).
D17. A flexural joint (360) in accordance with the preceding embodiment, wherein at least one of the first elastic arm (386) and the second elastic arm (388) are configured to allow at least one of
   a) the first mounting side (382) to move substantially linearly in the direction perpendicular to the surface of the first elastic arm (386), with respect to the fixed second mounting side (384), and
   b) the second mounting side (384) to move substantially linearly in the direction perpendicular to the surface of the second elastic arm (388) with respect to the fixed first mounting side (382).
D18. A flexural joint (360) in accordance with any of the preceding embodiments wherein the second flexural mechanism (380) is configured to provide linear flexibility of 0.5 to 15 mm, preferably 1 to 10 mm, even more preferably 1 to 5 mm up and/or down from the equilibrium.
D19. A flexural joint (360) in accordance with any of the preceding embodiments and with the features of embodiment D16, wherein the second flexural mechanism (380) is configured as a parallelogram flexure (380).

### System Embodiments

S1. A system for swapping a battery (400), comprising:
   a) at least one flexural joint (360) in accordance with any of the embodiments D1 to D19; and
   b) a battery station (10) configured to swap the battery (400).

### General Features

S2. A system in accordance with the preceding embodiment, wherein the at least one flexural joint (360) is configured to facilitate the battery (400) swapping by the battery station (10).
S3. A system in accordance with any of the preceding embodiments S1 to S2, wherein the at least one flexural joint (360) is configured to increase the tolerable misalignment for grabbing the battery (400) between the battery station (10) and the battery (400), said tolerable misalignment comprising at least one of the following:
   a) the maximum incorrect positioning of the battery (400) relative to the battery station (10), such that the battery station (10) is able to grab the battery (400); and
   b) the maximum incorrect positioning of the battery station (10) relative to the battery (400), such that the battery station (10) is able to grab the battery (400).

### Specific Embodiments

S4. A system in accordance with any of the preceding embodiments S1 to S3, wherein the battery station (10) comprises a battery grabber element (350) adapted to grab a battery (400) and wherein the battery grabber element (350) comprises a plurality of grippers (355) attached to the battery grabber element (350) using at least one flexural joint (360).
S5. A system in accordance with the preceding embodiment, wherein the flexural joint (360) comprises:
   a) a first group of rigid members, configured to mount the flexural joint (360) on the battery grabber element (350), comprising at least one of the following elements:
      i. a mounting base (374),
      ii. a top surface (378); and
   b) a second group of rigid members, configured to mount the grippers (355) to the flexural joint (360), comprising at least one of the following elements:
      i. a first mounting side (382),
      ii. a second mounting side (384).
S6. A system in accordance with any of the preceding embodiments S1 to S5 wherein the flexural joint (360) is adapted to increase the tolerance of the battery station (10) by at least 1 mm, preferably at least 2 mm, more preferably at least 5 mm by providing flexibility to the system.
S7. A system in accordance with the preceding embodiment and with features of embodiment S4 wherein the grippers (355) are configured to grip the battery (400) at least with the tolerance provided by the flexural joint (360).
S8. A system in accordance with the preceding embodiment wherein the flexural joint (360) is configured to elastically deform along at least two degrees of freedom.

### BRIEF DESCRIPTION OF THE DRAWINGS

The drawings shown and described below serve for illustration purposes only. They illustrate specific embodiments of the invention and do not intend to limit the scope of the present teachings in any way.

FIG. 1A shows a perspective view of an embodiment of a battery station,

FIG. 1B shows an inner perspective view of an embodiment of the battery station,

FIG. 2A shows an embodiment of a battery used with the battery station comprising rectangular pin layout,

FIG. 2B shows another embodiment of a battery used with the battery station comprising circular pin layout,

FIG. 2C shows an embodiment of a battery case used with the battery station,

FIG. 3A shows a front elevation view of a battery mounted in a station battery holder of a charging unit or in a robot battery holder of a mobile robot,

FIG. 3B shows a front elevation view of another embodiment of a battery mounted in a station battery holder of a charging unit or in a robot battery holder of a mobile robot,

FIG. 3C depicts an embodiment of a battery grabber element configured to provide feedback signal when successfully grabbing a battery;

FIG. 3D depicts another embodiment of a battery grabber element configured to provide feedback signal when successfully grabbing a battery;

FIG. 4A shows a general perspective view of an embodiment of a battery handling mechanism,

FIG. 4B shows a general perspective view of another embodiment of a battery handling mechanism,

FIG. 4C shows an enlarged view of an embodiment of a battery grabber element,

FIG. 4D shows a schematic view of a localization element,

FIG. 4E depicts a localization element comprising a camera,

FIG. 4F depicts a battery comprising a recognizable pattern,

FIG. 5A shows a front view of an embodiment of a flexural joint used with the battery station,

FIG. 5B shows a perspective view of the embodiment of the flexural joint,

FIG. 6 shows a schematic description of a battery swapping method according to an embodiment,

FIG. 7A shows a bottom view of a system comprising a mobile robot and a battery station,

FIG. 7B shows an embodiment of a hub comprising a mobile robot and a battery station wherein said battery station is integrated in the floor of the hub, and

FIG. 7C shows an embodiment of a system comprising a mobile robot, a battery station and a server.

### DESCRIPTION OF VARIOUS EMBODIMENTS

In this section, exemplary embodiments of the battery station 10 will be described, referring to the figures. These examples are given to only provide further understanding of the invention and do not intend to limit the scope of the present teaching in any way.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, time delays between steps can be present between some or all of the described steps.

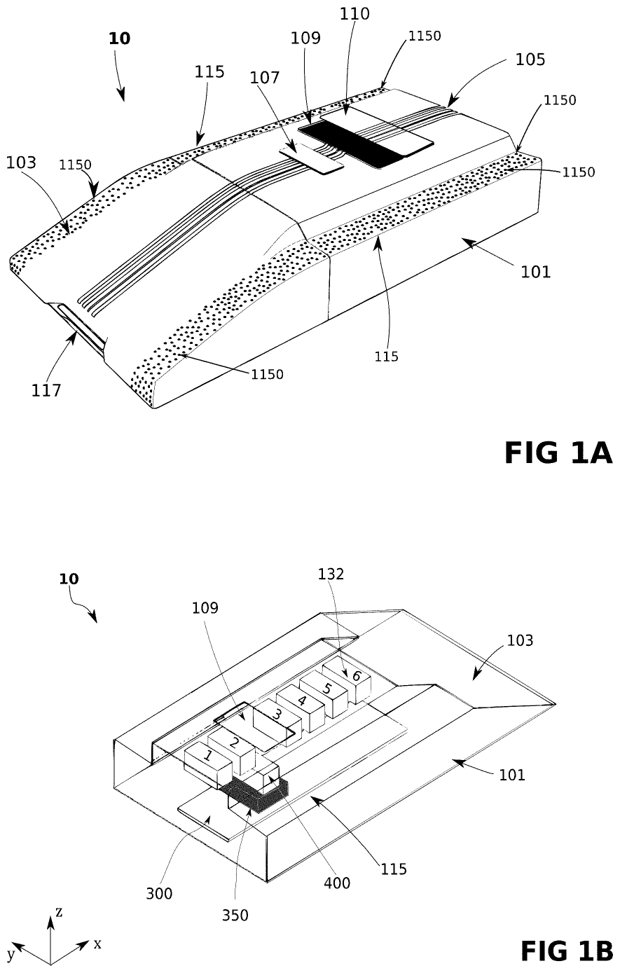

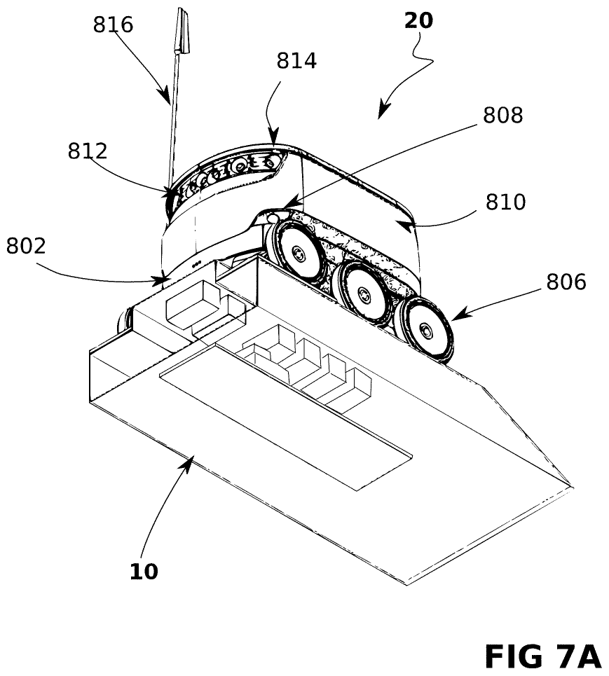

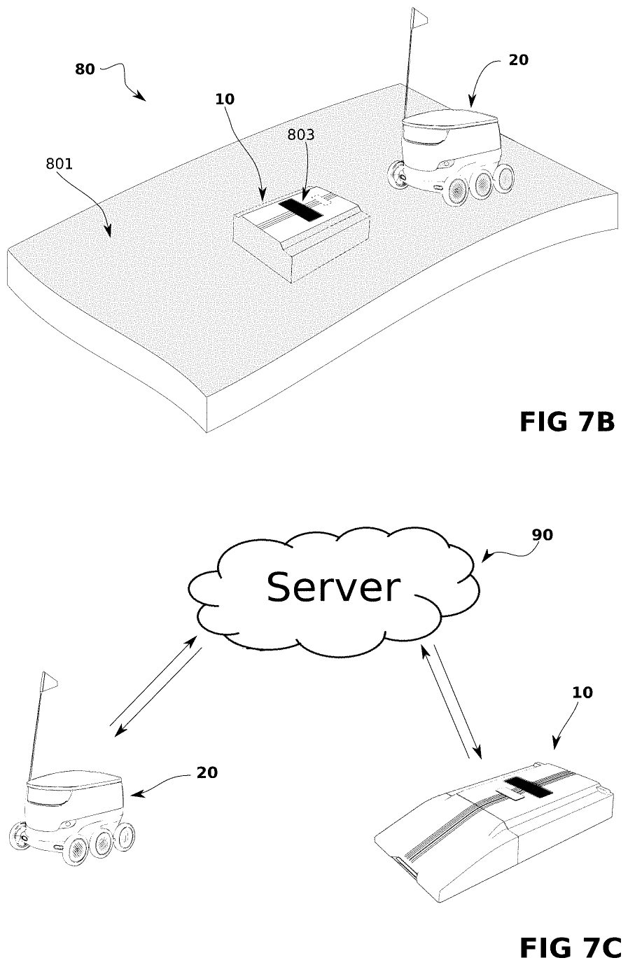

FIG. 1A depicts an outer perspective view of an embodiment of the battery station 10. Throughout the text, to keep the sentences clear and not overloaded, the battery station 10 may be referred to as station 10. The embodiment of the station 10 as depicted in FIG. 1A, may comprise a station body 101 encapsulating inner elements of station 10. The station body 101 can be a rigid material adapted to support the weight of a mobile robot 20 (shown in FIG. 7A) that can be serviced by the station 10. The station body 101 may comprise plastic material, such as acrylonitrile butadiene styrene (ABS). Further, the station body 101 may comprise a thickness in the range of 2 to 5 mm, such as 3 mm

In the front section of the station 10 a ramp 103 can be attached to the station body 101. The ramp 103 can assume a closed position and an open position (not shown in the figure). Further the ramp 103 may comprise a handle element 117. The handle element 117 can be adapted to open the ramp 103 such that inner elements of station 10 can be accessed by an operator. The handle element 117 can be further adapted to keep the ramp 103 fixed to the station body 101 when the ramp 103 assumes a closed position. The handle element 117 can be further adapted to remove the ramp 103 from the station body 101. In another embodiment of station 10, the ramp 103 may be a continuation of the station body 101 (i.e. there can be no distinct separation between ramp 103 and station body 101). In yet another embodiment, station 10 may not comprise the ramp 103. The ramp 103 can be inclined from the top of the station 10 to the ground such that the mobile robot 20 can easily approach station 10 to a battery load/unload position 115 (refer to FIG. 1B).

The battery load/unload position 115 can be a position configured to facilitate the operation of the station 10 on the mobile robot 20 such as the loading and unloading of the battery 400 to and from a mobile robot 20. That is, the battery load/unload position 115 can be a position configured such that, when the mobile robot 20 can be positioned in the battery load/unload position 115, the at least one of the batteries 400 of the mobile robot 20 can be aligned with the battery station 10, within a misalignment range of 0.1-2 cm, such as 1 cm. In a specific embodiment, the battery load/unload position 115 can be a position where the center of the battery 400 of the mobile robot 20 can be aligned with the center of the surface opening 109 of the station 10 in the X and Y coordinates, i.e. the center of the battery 400 of the mobile robot 20 can comprise the same X and Y coordinate with the center of the surface opening 109, when the mobile robot 20 can be positioned in the battery load/unload position 115 (refer to the reference axis provided in FIG. 1B).

According to an embodiment, station 10 can be configured to facilitate the positioning of the mobile robot in the battery load/unload position 115. In such embodiments, the station 10 can further comprise at least one guiding element 105, preferably a plurality of guiding elements 105. The guiding elements 105 can be adapted to facilitate the positioning of the mobile robot 20 to the battery load/unload position 115. In a preferred embodiment, the guiding elements 105 can comprise at least one marker 105, preferably a plurality of optical markers 105. In a more preferred embodiment, the at least one guiding element 105 can be configured as a straight line 105, preferably as a plurality of straight lines 105. The station 10 can preferably comprise 2 to 10 straight lines that can be configured to indicate the battery load/unload position 115. The horizontal lines 105 can comprise colors preferably distinguishable from the colors of station body 101. In an exemplary embodiment, the station body 101 may comprise a dark grey color, and the horizontal lines 105 may comprise white or bright yellow color. The mobile robot 20, by means of optical sensors and/or cameras 812 (refer to FIG. 7A), can be adapted to sense the horizontal lines 105 and can continue to drive until it cannot sense the horizontal lines 105 anymore. Lengths of the horizontal lines 105 can be adapted such that to direct the mobile robot 20 to the battery load/unload position 115.

In some embodiments, the straight lines 105 can be configured as an identifier for the battery station 10 or for a specific group of battery stations 10. That is, the battery station 10 or a specific group of battery stations 10 can comprise a specific width of any of the plurality of straight lines 105. The battery station 10, or a specific group of battery stations 10 can also comprise a specific length of any of the plurality of straight lines 10. The battery station 10 or a specific group of battery stations 10 can also comprise a specific distance between any of the plurality of straight lines 105. The battery station 10 or a specific group of battery stations 10 can comprise a specific color of any of the plurality of straight lines 105. The battery station 10 or a specific group of battery stations 10 can also comprise a specific number of straight lines 105. Such a feature of the straight lines 105 can be advantageous for the battery station 10 and preferably for the mobile robot 20, as it can uniquely identify a battery station 10, or a specific group of battery stations 10. Thus, the mobile robot 20 can know which of the battery station 10 or which group of the battery stations 10 it is using. The straight lines 10 configured as a battery station identifier can also be advantageous, as they avoid the need of implementing a separate identifier on the battery station 10 by integrating it into the plurality of the straight lines 105.

Additionally, the positioning of the mobile robot 20 in the battery load/unload position 115 can be facilitated by the high friction material 1150 or a high friction surface topography etc. The high friction material 1150 can be placed on the surface of the battery station 10, more preferably, on the surface of the battery station 10 that can be contacted by the wheels of mobile robot 20 (see FIG. 7A for more details on the mobile robot 20). As depicted in FIG. 1A, the high friction material 1150 can cover part of or all of the battery load/unload position 115 of station 10. Additionally or alternatively, the high friction material 1150 can cover part or all of the ramp 103, preferably part of the ramp 103 wherein it can be expected for the wheels of the robot 20 to contact the ramp 103, such as, on the sides of the ramp 103 as depicted in FIG. 1A.

The high friction material 1150 can comprise a material with a high friction coefficient. Thus, the high friction material 1150 positioned between the battery station 10 and the wheels of the mobile robot 20, while the mobile robot 20 drives on the battery station 10, can provide a contact surface with a higher friction coefficient between the station 10 and the robot 20—as compared to the case when the high friction coefficient 1150 is not provided. This may result in the reduction or elimination of slippage of the wheels 806 of the mobile robot 20 (see FIG. 7A) while driving on the station 10, which in turn can facilitate a more accurate positioning of the mobile robot 20 on the battery load/unload position 115. For example, the mobile robot 20 may use, among other sensors, an odometer for measuring the distance it travels based on wheel rotations. Slippage of the wheels of robot 20, cause “empty rotations”, that is, part of rotation of the wheels of the robot 20 does not contribute on movement of the robot 20. Hence, the data received by the odometer may lose accuracy in instances of wheel slippages, which can cause an inaccurate positioning of the robot 20 on the load/unload position 115. However, the application of the high friction material 1150 on the surface of the station 10 that can be contacted by wheels of robot 20, can reduce or eliminate slippage of wheels of the robot 20, and thus, contributing on a better positioning of the robot 20 on the battery load/unload position 115.

The high friction material 1150 can be applied on the surface of station 10 like an ink, adhesive and/or layer 1150 configured for comprising a high friction coefficient. For example, the ink or layer 1150 can create a non-smooth surface on top of or adhered to the surface of station 10 wherein it can be applied on. The surface of the station 10 that can be contacted by the robot 20, such as, on the sides of the ramp 103 and the battery load/unload position 115, can be treated or painted with the ink 1150 or a layer 1150 can be adhered therein, hence resulting in a less smooth surface with a higher friction coefficient 1150.

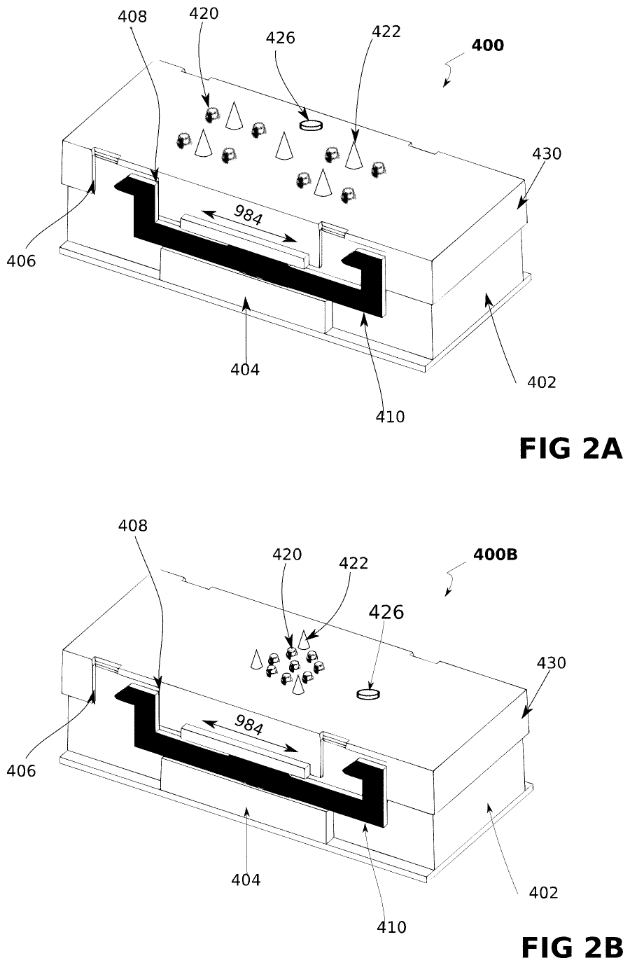

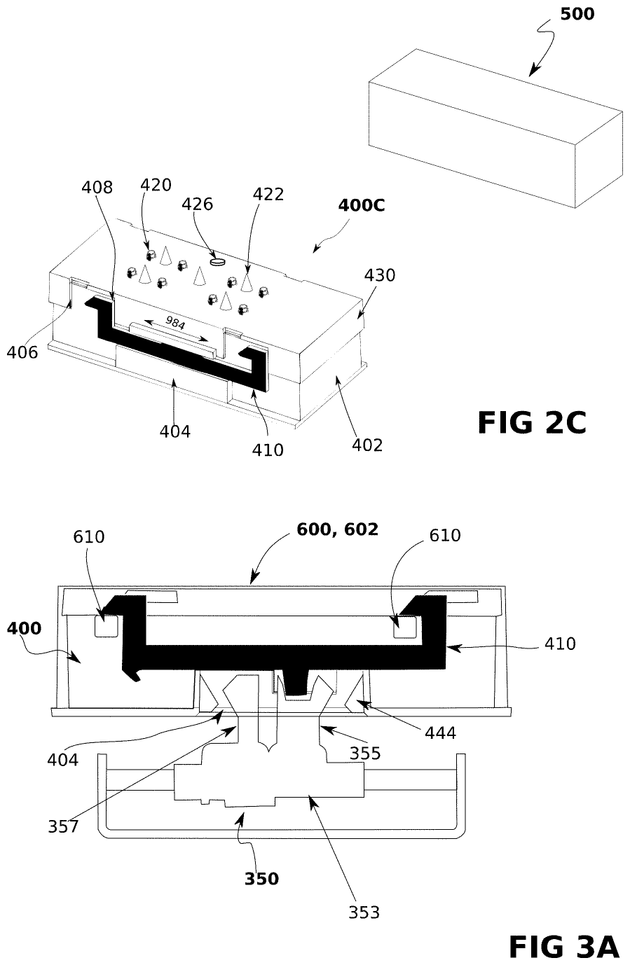

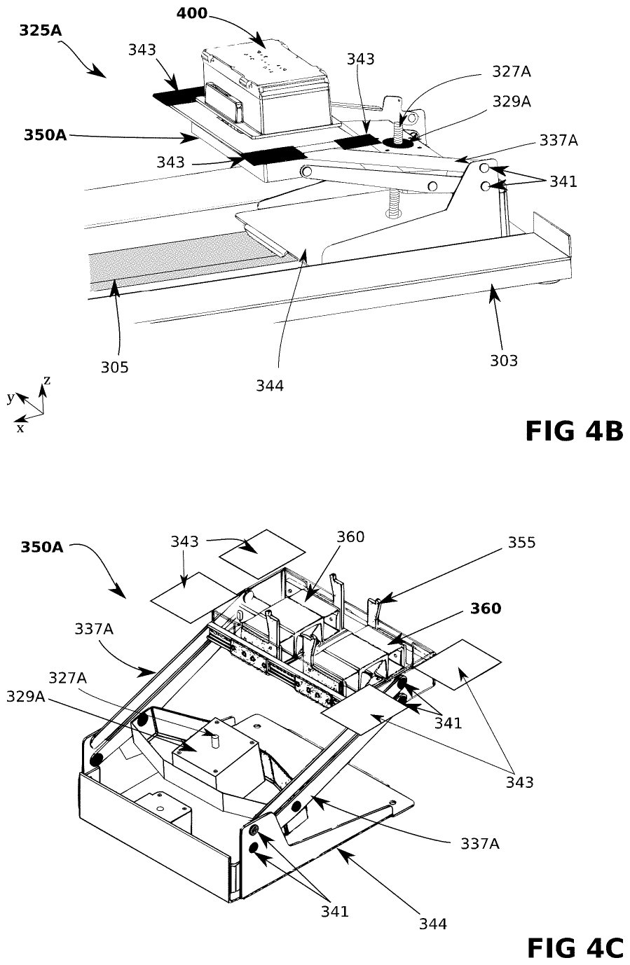

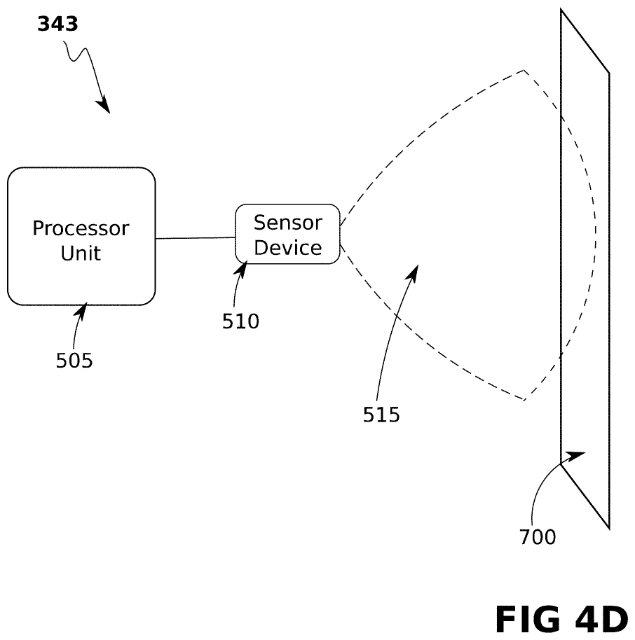

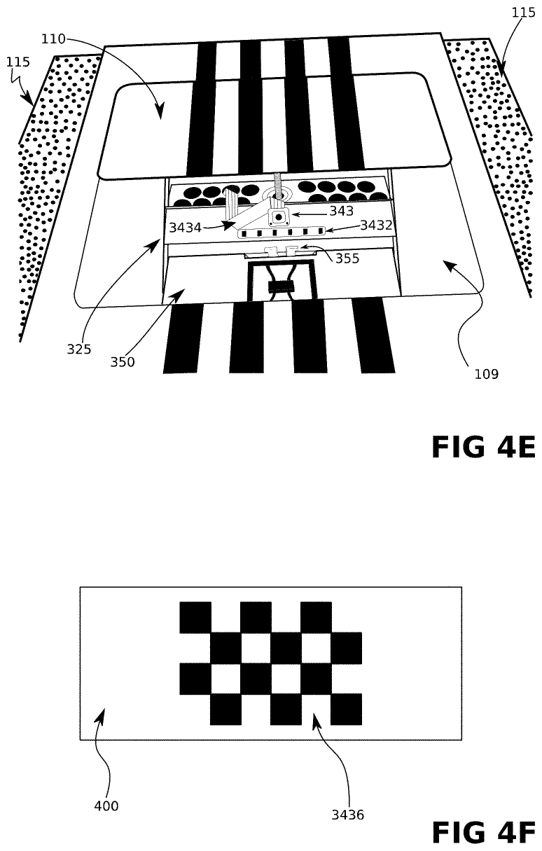

Further, the battery station 10 can comprise a surface opening 109 that can be adapted to allow a battery handling mechanism 300, which may also be referred to as handling mechanism 300 (refer to FIG. 4A, 4B) to access the battery 400 (refer to FIG. 2A, 2B, 2C) of the robot 20, when the robot 20 is positioned in the battery load/unload position 115. In an embodiment of station 10, the surface opening 109 can be further adapted to allow the battery 400 pass through it, i.e. the surface opening 109 comprises dimensions slightly bigger or bigger than the battery 400, such that the battery handling mechanism 300, can at least one of load and unload the battery 400 from the mobile robot 20.

Further, the surface opening 109 may comprise a covering element 110. The covering element 110 of the surface opening 109 can be adapted to prevent external objects such as dust, mud, stones, etc., from entering inside the station 10. Such external objects may damage the inner elements of the station 10, if allowed entry. Thus, to make station 10 more robust to such damages from external objects, the covering element 110 can be provided. The covering element 110 can also secure that unauthorized persons access the inner elements of station 10. The covering element 110 can assume an open and a closed position. In FIG. 1A only the open position of the covering element 110 is shown, i.e. the covering element 110 can slide over the surface of the battery station 10, thus opening or uncovering the top opening 109. When the covering element 110 is in the open position, the battery 400 and the handling mechanism 300 can pass through the surface opening 109. When the covering element 110 is in the closed position, it covers the surface opening 109, thus isolating the inside of station 10 from the outside. In one embodiment, the covering element 110 can be attached by one of its edges to the corresponding edge of the surface opening 109 by means of a rotational joint (not shown). In such an embodiment, the covering element 110 can rotate with respect to the edge of joint, thus opening and closing the surface opening 109. In another embodiment, the covering element 110 of the surface opening 109 can slide beneath the surface of station 10 to assume the said opening position. In yet another embodiment, as depicted in FIG. 1A, the covering element 110 can slide over the surface of the battery station 10 to assume the opening position—i.e. to uncover or open the top opening 109.

In one embodiment, the covering element 110 of station 10 can be opened by the handling mechanism 300. When the handling mechanism 300 approaches the surface opening 109, it can apply a force on the covering element 110, thus forcing it to open. In such embodiments, the covering element 110 can be adapted to easily open i.e. a small force is required to open it, so that the structure of the station 10 and/or handling mechanism 300 cannot be damaged. In another embodiment, the covering element 110 can be automatically controlled by the controllers of station 10. In such embodiments, moving actuators (not shown) can be provided for the covering element 110, which can be controlled by the controllers of station 10 to open and/or close the covering element 110.

Station 10 can further comprise an identification element 107. The identification element 107 can be adapted to be read by the mobile robot 20 such that the mobile robot 20 can recognize at which station 10 it is currently located. In a preferred embodiment, each station 10 or each group of stations 10 can comprise a unique identification element 107. The identification element 107 preferably can be a QR code 107 that can be read by optical sensors and/or cameras 812 of the mobile robot 20.

Station 10 can further comprise a plurality of wheels (not shown) attached to the bottom of the station body 101 such that the station 10 can be moved freely and/or in a guided manner. Station 10 may comprise a motor (not shown) which would further facilitate the movements of the station 10. In another embodiment, the station 10 may be remotely controlled by an operator. In yet another embodiment, the station 10 can be adapted to move autonomously or semi-autonomously. In a hazard situation, the battery 400 of the mobile robot 20 can drain below the expected energy level required for the robot 20 to approach a hub 80, or a station 10. In such a situation, an operator can remotely control station 10, to approach the said mobile robot 20 with the drained battery 400 and/or the station 10 can semi-autonomously drive to the location of the said mobile robot 20. When station 10 approaches the said robot 20, the battery swapping procedure (described below) can initiate. A hazard situation can also be a situation when the battery 400 malfunctions.

Typical dimensions of the station 10 may be as follows. Width: 30 to 100 cm, preferably 50 to 70 cm. Height: 15 to 35 cm, preferably 20 to 25 cm. Length: 50 to 150 cm, preferably 80 to 110 cm.

Referring now to FIG. 1B, an inner perspective view of an embodiment of station 10 is shown. In this figure, for a better illustration of the inner elements of station 10, the station body 101 and ramp 103 of station 10 are neglected and shown as transparent. Station 10 can comprise at least one battery charging unit 132, which can be also referred to as charging unit 132. In a preferred embodiment, station 10 can comprise a plurality of battery charging units 132, preferably 2-10 charging units 132, more preferably 3-5 charging units 132, such as 3 charging units 132. In FIG. 1B, station 10 comprises six battery charging units 132, numbered from 1 to 6. It should be noted that this numbering is done for illustration purposes only.

Battery charging units 132 can be adapted to at least one of hold and charge the batteries 400. That is, in an embodiment the battery charging units 132 can be configured to hold at least one battery 400, i.e. keep the battery 400 fixed to battery charging unit 132. In another embodiment, the battery charging unit 132 can be configured to charge the battery 400. In a preferred embodiment, the battery charging unit 132 can be configured for both hold and charge a battery 400.

Further, the battery charging unit 132 can be configured to charge the batteries 400 at variable rates, such as with variable charging currents. The charging rate can be adjustable to the charging unit 132, preferably at the beginning or during the battery 400 charging process. The charging rate can be adjusted by a remote operator. In an embodiment, the charging rate of the charging units 132 can also be adjusted by the controllers of the station 10. The charging rate can be chosen based on different factors such as: the capacity of the battery 400, temperature of the battery 400, temperature of the charging unit 132, required time for the battery 400 to be charged, etc. The battery charging units 132 can be preferably configured to charge with a minimum rate of 0.6 C to 4 C, more preferably 1 C to 3 C, with C referring to the capacity of the battery 400 being charged, or with C referring to a battery capacity taken as a reference capacity. Thus, charging with lower rates, such as 0.6 C can require more time to charge the battery and, charging with higher rates, such as 4 C can require less time. Usually, charging with higher rates can have destructive effects on the batteries, such as reducing the lifetime of the battery. Thus, deciding on a charging rate can be a trade-off between considering battery health and reducing the time needed to charge the battery.

Further, the charging units 132 may indicate to the controller unit (not shown) of station 10 if they occupy a battery 400. A battery charging unit 132 that can be at least one of holding and charging a battery 400 can be referred to as an occupied charging unit 132. The charging units 132 may indicate to the controller unit (not shown) of station 10 if they do not occupy a battery 400. A battery charging unit 132 that is not holding and charging a battery 400 can be referred to as an unoccupied charging unit 132. The charging units 132 may also indicate to the controller of station 10 the charging level of the battery 400 they are occupying. Thus, the station 10 can know at every moment which of its battery charging units 132 is occupied by a battery 400 and at the same time can know which of the batteries 400 positioned in its charging units 132 are fully charged and can be used for swapping. The controller unit of station 10 can be programmed to use different algorithms for making the decision of assigning the current discharged battery 400, unloaded from the mobile robot 20, to a charging unit 132 or choosing a charged battery 400 from the charging unit 132 and loading it to the mobile robot 20. An example of such an algorithm can be First-In-First-Out (FIFO) algorithm, i.e. the first battery that finished the charging process will be used for the next battery swapping.

As depicted by FIG. 1B station 10 can further comprise a battery handling mechanism 300 preferably attached to the base of the station body 101. The handling mechanism 300 can be adapted to move the grabber element 350 a precise distance, in its reaching range, in the x, y, z directions as depicted by the reference axes shown in FIG. 1B. Said reaching range can be the space comprising the charging units 132 of charging station 10 and the battery 400 of a mobile robot 20 wherein said robot 20 is positioned in the battery load/unload position 115. Thus, given a specific point p(x₁, y₁, z₁) in the reaching range of the handling mechanism 300, the handling mechanism 300 can position, the grabber element 350, for example the center point of the grabber element 350, at point p(x₁, y₁, z₁), within the range of some positioning error ε. The value of ε depends on the actuators comprised by the battery handling mechanism 300. The positioning error ε, should preferably be less than 10 mm, more preferably less than 5 mm, even more preferably less than 2 mm.

Referring to FIG. 2A, an enlarged view of an embodiment of the battery 400 that can be used by station 10 is shown. Internal elements (not shown) of the battery 400 can be encapsulated by battery body 402. On the top the battery body 402 can comprise a battery lid 430. The battery lid 430 can be attached on the rest of the battery body 402. In an embodiment, the battery lid 430 can assume a closed and/or an open position (not shown). When the battery lid 430 assumes the closed position, it can cover the top surface of the battery body 402, thus enclosing the internal elements of the battery 400. When the battery lid 430 assumes the open position, the internal element of the battery 400 can be exposed. An operator can have access to the internal elements of the battery 400 and/or replace or fix the elements of the battery 400. In another embodiment of the battery 400, the battery lid 430 can be a continuation of the battery body 402, i.e. there can be no clear distinction between the battery body 402 and the battery lid 430. Yet in another embodiment the battery body 400 may not comprise a battery lid (430).

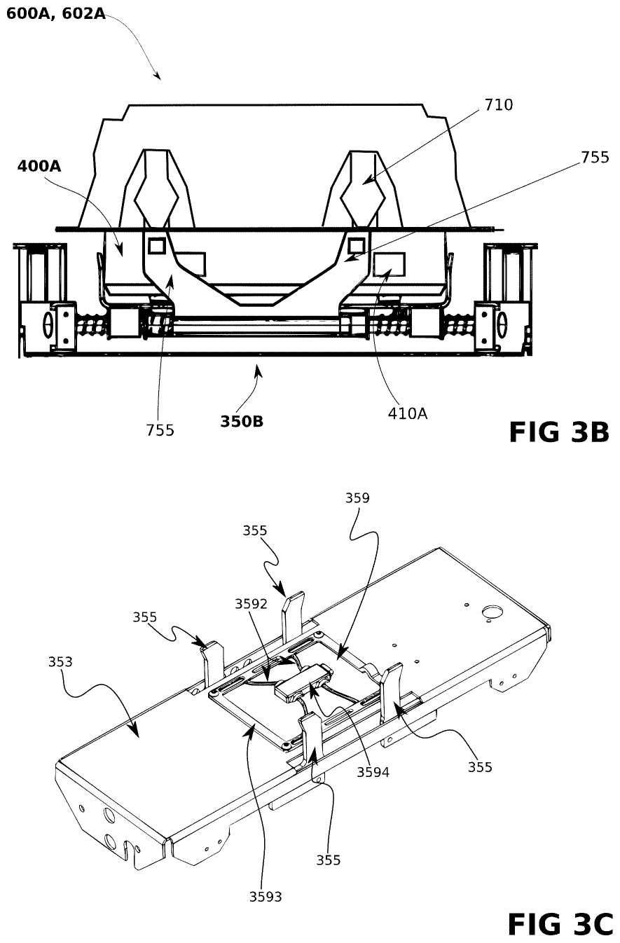

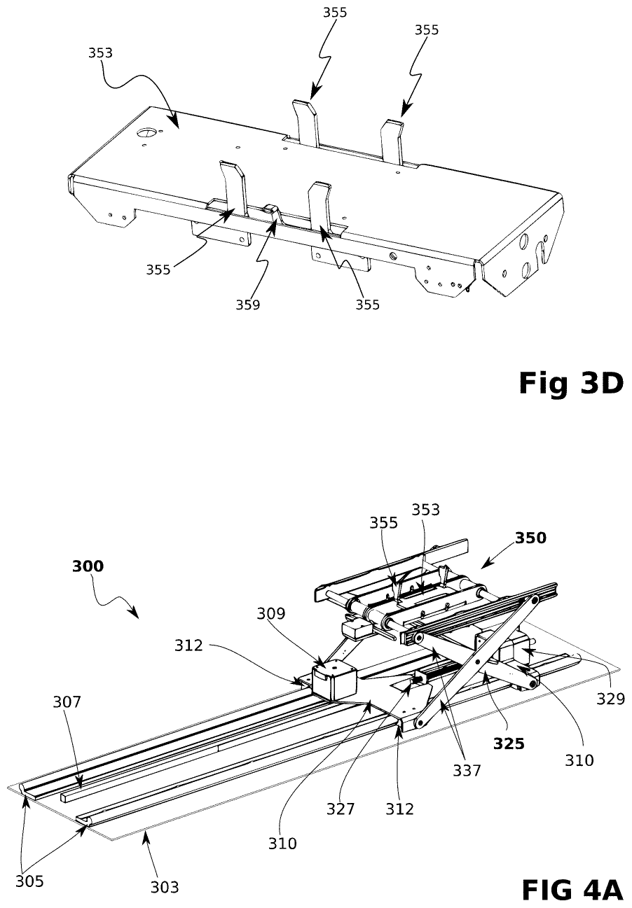

Further, the battery 400 can comprise a plurality of electrical connectors 420, preferably a plurality of electrical pins 420. In the embodiment depicted in FIG. 2A, the electrical connectors can be attached on the battery lid 430. These electrical pins 420 can be adapted to electrically connect the battery 400 with the battery charging units 132 and/or the mobile robot 20. They can be further adapted to provide extra support for the battery 400, damping to some level the vibrations of the battery 400 due to the movements of the mobile robot 20. In an embodiment, the station battery holder 600 and the robot battery holder 602 (refer to FIG. 3A, FIG. 3B) can comprise electrical contact points (not shown) configured to create contact with the electrical pins 420 when the battery 400 is positioned respectively in the station battery holder 600 or the robot battery holder 602. That is, in such embodiments, the electrical contact points can allow the station battery holder 600 and the robot battery holder 602 to electrically connect with the electrical pins 420, and thus the battery 400, when the battery 400 is positioned in the station battery holder 600, or the robot battery holder 602. In another embodiment, the station battery holder 600 and/or the robot battery holder 602 can comprise pin insertion places (not shown), where electrical pins 420 can be inserted to establish an electric connection between the battery 400 and respectively the station battery holder 600 or the robot battery holder 602. In another embodiment, the station battery holder 600 and the robot battery holder 602 can comprise a combination of the electrical contact points and pin insertion places, configured to establish an electric connection between the battery 400 and respectively the station battery holder 600 or the robot battery holder 602.

In one embodiment, the battery 400 can further comprise at least two damping pins 422. In a preferred embodiment, the battery 400 can comprise a plurality of damping pins 422. In the embodiment depicted in FIG. 2A, the battery 400 comprises a plurality of damping pins 422 attached in the battery lid 430. The at least two damping pins 422 can protrude from the battery body 402. The damping pins 422 comprise a distal top and a proximal base. The proximal base is located closer to the battery body 402 than the distal top. The minimum bounding circle of the proximal base is larger than the minimum bounding circle of the distal top. In a simple example, the damping pins 422 can be pyramid or cone shaped (or, preferably, shaped as a truncated cone or pyramid). However, the damping pins 422 can comprise different shapes, as long as the minimum bounding circle of the base is larger than that of the top. The minimum bounding circle refers to the smallest circle encapsulating the whole area of the base and the top respectively.

In an embodiment, the robot battery holder 602 and the station battery holders 600 can comprise a plurality of damping pin insertion places (not shown), where the damping pins 422 can be inserted. In another embodiment, the robot battery holder 602 and the station battery holder 600, may not comprise the damping pin insertion places. The damping pins 422 can be adapted to provide extra fixing means of the battery 400 to the robot battery holder 602 or the charging units 132 of station 10. The damping pins 422 can be adapted to damp possible vibrations of the battery 400 when the battery 400 can be attached to the mobile robot 20 or when attached to the charging units 132. As the mobile robot 20 moves, this can cause vibrations of the battery 400. These vibrations can damage the structure of the battery 400, for example, they can damage the electrical pins 420, the battery lid 430, the battery cells (not shown), the inner circuitry of the battery (not shown) etc. Particularly the electrical connectors 420 can, over time, deform the electronics they can be connected to if not balanced out by the damping pins 422. The same situation can happen when the battery 400 can be attached to one of the charging units of the station 10, where possible vibrations can be produced by the station 10 being in motion, by the operation of the station 10 etc. At the same time, these vibrations can also cause possible damages to the structure of the mobile robot 20 or charging units 132, more specifically to the robot battery holder 602 and/or to the station battery holder 600. Thus, to avoid these damages and/or to provide a longer life for the battery 400, robot 20 and/or station 10 the damping pins 422 can be provided. When the battery 400 can be attached to a robot battery holder 602 and/or station battery holder 600, the damping pins 422 can be inserted in their respective damping pin insertion places, consequently the battery will be attached to the battery holders 600 and/or 602 in a more fixed manner, thus it will be more robust to vibrations. Alternatively, no insertion places may be provided, and the damping pins 422 can compensate for the force applied by the electrical connectors 420.

Battery 400 can further comprise at least one battery status transmitter 426. In a preferred embodiment, the battery status transmitter can comprise an infrared transmitter and/or receiver 426, such as an infrared sensor 426. In the embodiment depicted in FIG. 2A, the battery status transmitter 426 can be attached to the battery lid 430. The battery status transmitter 426 can be adapted to transmit information related to the status of the battery 400. Such information can include the unique battery ID and/or the charging level of the battery 400, and/or other battery parameters such as charging cycles. The mobile robot 20 and/or the station 10 can be adapted to detect, sense and/or decode the information transmitted by the battery status transmitter 426. In the preferred embodiment, wherein the battery status transmitter 426 can comprise an infrared sensor 426, the mobile robot 20 and/or the station 10 can also comprise a second infrared sensor (not shown) adapted to detect, sense and/or decode the signals emitted by the battery infrared sensor 426. The information received can then be processed by the controller units of the mobile robot 20 and or the controller units of the charging station 10, to create a history for each of the batteries 400, to count the number of charge-discharge cycles that a certain battery 400 has experienced, to decide on the charging time of a certain battery 400 and/or to decide whether a battery requires service, etc. Other benefits of the battery status transmitter 426 are explained further in this document, with reference to the mobile robot 20, when describing FIG. 7A.

Further, the battery 400 can comprise a fixing unit 410, which may also be referred to as a latch/unlatch mechanism 410. In some embodiments, the battery 400 can comprise at least one fixing unit 410, preferably a plurality of fixing units 410, such as two fixing units 410. The plurality of fixing units 410 can be configured to fix the battery 400 to the station battery holder 600 or the robot battery holder 602 in a more rigid manner. That is, the plurality of fixing units 410 can create a stronger support for the battery 400. The plurality of fixing units 410, such as two fixing units 410, can be positioned on opposite sides of the battery 400. This can be advantageous as it can prevent possible non-intended inclinations of the battery 400 relative to the station battery holder 600 or the robot battery holder 602 when the battery 400 is attached respectively to the station battery holder 600 or the robot battery holder 602. Such inclinations can cause damages on the structure of the battery 400 or to the structure of the station battery holder 600 or the robot battery holder 602. Such inclinations can further electrically disconnect the battery 400 from the station battery holder 600 or the robot battery holder 602.

The fixing unit 410 can be configured to fix the battery 400 to the robot battery holder 602 or station battery holder 600. That is, the fixing unit 410 can be configured to keep the battery 400 fixed and preferably non-movable in the robot battery holder 602 or station battery holder 600. The fixing unit 410 can also be configured to support at least the weight of the battery 400. This can be particularly advantageous if an external force, such as gravity, acts on the battery, tending to displace the battery from the intended position in the robot battery holder 602 or station battery holder 600. The fixing unit 410, can move back and forth in a direction as depicted by double arrow 984, within a distance limited by walls 406 and 408 of the battery body 402. It should be noted, that the double arrow is shown here just for illustration purposes and is not part or element of any embodiment of battery 400. In an embodiment, the fixing unit 410 can comprise a sliding latch configured to move along the battery body 402 between a closed position and an open position. The fixing unit 410 positioned in the closed position can be configured to extend in the structure of the station battery holder 600 or the robot battery holder 602 to latch the battery 400 to the station battery holder 600 or the robot battery holder 602. The fixing unit 410 positioned in the open position is configured to unlatch the battery 400 from the station battery holder 600 or the robot battery holder 602.

Further, the battery body 402 can comprise a protruding structure 404 to help fix the fixing unit 410 on the battery 400. The protruding structure can be further configured to allow the grabber element 350 (refer to FIG. 3A) to grab the battery 400. The grabber 350 can move the fixing unit 410 of the battery 400 back and forth to release/fix the battery 400 from/to the latches 610 of the station battery holder 600 and the robot battery holder 602 (refer to FIG. 3A).

Referring now to FIG. 2B, another embodiment of the battery 400 is shown, referred as battery with circular pin layout 400B, or simply as battery 400B. Similar to the embodiment of the battery 400 depicted in FIG. 2A, the battery 400B can comprise a battery body 402, a battery lid 430, electrical pins 420, damping pins 422, battery status transmitter 426, latch/unlatch mechanism 410, limiting walls 406, 408 and/or the protruding structure 404. These components comprised by the battery embodiment 400B can be similar to the components of the battery embodiment 400 depicted in FIG. 2A and therefore their description is omitted. The description of these components made for the embodiment of FIG. 2A, can be also valid for the components of the battery 400B. What differs the embodiment of the battery 400 depicted in FIG. 2A, from the embodiment of the battery 400B depicted in FIG. 2B, is the layout of the electrical and damping pins 420, 422. In FIG. 2A, the battery 400 comprises a substantially rectangular layout of the electrical and damping pins 420, 422. In FIG. 2B the embodiment of the battery 400B comprises a substantially circular layout of the electrical and damping pins 420, 422. It should be noted that the embodiments depicted in FIG. 2A and FIG. 2B are illustrative embodiments for the battery 400. Other embodiments of the battery 400, e.g. with different layouts of the electrical and damping pins 420, 422 may be used with the station 10. It should be noted, that throughout this document, for simplicity reasons, and to keep the sentences clear, whenever referring to the battery 400, only reference to the embodiment of the FIG. 2A is explicitly provided, with the numeral 400. Whenever referring to the battery 400, reference to the embodiment 400B and other embodiments of the battery should be implied.

In another embodiment, the battery body 402 and the battery lid 430, comprising the elements 420, 426, 422, 408, 406, 404 and/or 410, described in the preceding paragraphs, can be a component on its own as depicted by battery case 400C, shown in FIG. 2C. The battery case 400C comprises a battery case body 402, and/or a battery case lid 430. It can further comprise a plurality of electrical connectors 422, at least two damping pins 422, a battery status transmitter 426, at least one latch/unlatch mechanism 410, limiting walls 406, 408, and/or a protruding structure 404. The outer structure of the battery case 400C can be similar to the outer structure of the battery 400. Therefore, they can comprise similar elements and the description for these elements is omitted, since the elements 402, 430, 420, 426, 422, 408, 406, 404 and 410 are described in the preceding paragraphs.

In one embodiment, the battery case 400C can encapsulate the inner elements (not shown) of the battery 400. Inner elements of the battery 400 may refer to any element of the battery 400 that is not exposed to the surroundings, i.e. can be encapsulated by the battery body 402, battery lid 430 and/or the battery case 400C, such as the battery cells, the required wiring for transmitting the electric charges in and out of the battery 400, the required circuitry for charging, discharging and/or other functionalities of the battery 400, like the circuitry needed for battery status transmission, etc. Thus, in such an embodiment, the battery 400 comprises the inner elements (like the examples provided in the preceding sentence) which can be enclosed by the battery case 400C. In this embodiment, the manufacturing of the battery can be separated from the manufacturing of the inner elements and the production of the battery case 400C. Thus, during the manufacturing of the battery 400, the inner elements can be adapted to fit in the battery case 400C and/or the battery case 400C can be adapted to encapsulate and/or hold the inner elements of the battery 400.

In another embodiment, the battery case 400C can serve as a battery adapter 400C. Different mobile robot battery standards exist in the state of the art. In this document, it is referred to such batteries as universal mobile robot batteries 500. A universal mobile robot battery can be any battery that can be used by a mobile robot 20. An example of a universal mobile robot battery 500 can be the battery 400. Thus, the universal mobile robot battery 500 refers to a more general class of robot batteries than the battery 400. In one embodiment, the universal robot battery 500 can be adapted to be inserted into, i.e. encapsulated by the battery case 400C.

In a preferred embodiment, the battery case 400C can be adapted to encapsulate the universal robot battery 500. The adapter means can refer to, for example, means for establishing an electrical connection (not shown), means for keeping the battery 500 fixed to the battery case 400C (not shown), etc. The adapter means can further include electronic and/or electric circuitries (not shown) for adapting the voltage, current and/or power produced by the universal robot battery 400C, to the voltage, current and/or power required by the device using the universal robot battery 400C such as a mobile robot 20, a station 10, etc. The battery case 400C serving as an adapter for the universal robot battery 500 can be facilitated further if the 3D printing technology can be used for the production of the battery case 400C. In such an embodiment, the battery case 400C, can allow the use of a more general class of batteries 500 to be used by the station 10 and/or the mobile robot 20, than the one depicted by the battery 400.

It should be noted, that whenever referring to the battery 400, reference to the battery case 400C encapsulating a universal mobile robot battery 500 can be implied as well. For clarity, explicit reference to battery case 400C encapsulating a universal mobile robot battery 500 is avoided by referring only to the battery 400.

Referring now to FIG. 3A, an embodiment of a station battery holder 600 of the charging unit 132 is shown. The robot battery holder 602 comprises similar elements as the station battery holder 600. For this reason, explicit figures for both the station battery holder 600 and the robot battery holder 602 are not shown. Thus, in this paragraph whenever referring to station battery holder 600, reference to robot battery holder 602 should be implied. The station battery holder 600 can comprise a cavity, which in the figure is shown to be occupied by the battery 400. The cavity of the station battery holder 600 can be adapted to enclose or encapsulate the battery 400. Further, the station battery holder 600 can comprise a fixing element 610 that keep the battery 400 fixed to the station battery holder 600 once the battery 400 can be attached to it. The fixing element 610 can comprise latches 610 as shown in FIG. 3A. Latches 610 can be some elongated parts extended from the body of station battery holder 600, adapted to support the weight of the battery 400.

In FIG. 3A, the battery grabber element 350 of the battery handling mechanism 300 of the station 10 is shown in more detail. The battery grabber element 350 can comprise a grabber element frame 353. The grabber element frame 353 can be adapted to attach the grabber 350 to the battery handling mechanism 300. Further, the grabber element 350 can comprise two pairs of grippers: grabbing grippers 355 and supportive grippers 357. Grippers 355 and 357 can be attached on both sides of the grabber element frame 353 such that each side of the grabber element frame 353 comprises at least one grabbing gripper 355 and one supportive gripper 357. The grabbing grippers 355 can be adapted to grab the fixing unit 410 of the battery 400. Supportive grippers 357 can be adapted to provide extra support so that the grabber element 350 can hold the battery 400 while loading, unloading and/or transporting it. In another embodiment, the grabber element 350 can comprise only the grabbing grippers 355. In yet another embodiment, the grabber element can comprise only the supportive grippers 357. In another embodiment, the grabbing grippers 355 can be adapted to also support the battery 400. In yet another embodiment, the supportive grippers 357 can be adapted to also grab the fixing unit 410 of the battery 400. In another embodiment, the grabber element 350 can comprise an actuator (not shown) wherein the said actuator can be configured to move the grabbing grippers 355 and/or the supportive grippers 357. Said actuator can be controlled by the controller units of the station 10, to move the grabbing grippers 355 and/or the supportive grippers 357 in a certain manner configured for grabbing and/or releasing the battery 400 from the grabber element 350.

For a better understanding on how the grabber element 350, the station battery holder 600 and the battery 400 interact, a load/unload procedure of the battery 400 from the station battery holder 600 is described in the following. To unload the battery 400 from the station battery holder 600, the grabber 350 can first attach itself to the battery 400 by attaching its grabbing grippers 355 to the fixing unit 410 of the battery 400. Then, the grabber element 350 can proceed by detaching the battery 400 from the station battery holder 600. This can be accomplished by moving the fixing unit 410 away from the latches 610. In an embodiment, the grabbing grippers 355 can unlock the battery 400 from the station battery holder 600, by moving the fixing unit 410 away from latches 610 a predefined distance. That is the grabbing grippers 355 can reach a specific unlocking position. The battery grabber element 350 can be configured so that a feedback signal is communicated to the controllers of the station 10 when grabbing grippers 355 reach said specific unlocking position while unlocking the battery 400 from the station battery holder 600. When such a feedback signal is processed in the controllers or in a processing component of station 10, the controllers of station 10 can confirm that the grabbing element 350 was able to successfully unlock and grab the battery 400 from the station battery holder 600 (see FIGS. 3C and 3D for embodiments of the grabber element 350 configured to provide at least one feedback signal when it successfully grabs the battery 400). The protruding structure 404 can comprise an extended element 444, which can also be referred to as the ear 444. In a preferred embodiment, the ears 444 are positioned in the inner part of the protruding structure 404, in both sides of the protruding structure 404. The respective ears 444 can be allowed contact with the respective grabbing grippers 355 and the supportive grippers 357, when the grabber element 350 unlatches the battery 400 from the latches 610, i.e. moves the fixing unit 410 away from the latches 610. In a specific example, when the grabber element 350 unlatches the battery 400, the grabbing grippers 355 and the supportive grippers 357 move toward the respective ear 444. This way, when the battery handling mechanism 300 moves the battery grabber 350 away from the station battery holder 610, the contact between the grippers 355, 357 and the respective ear 444, makes it possible for the battery 400 to follow the movement of the battery grabber element 350. The battery handling mechanism 300 can move the grabber element 350 away from the station battery holder 600, thus unloading the battery 400 from the station battery holder 600 Similar unloading procedure can also be done for unloading a battery 400 from the robot battery holder 602.

To load the battery 400 to the station battery holder 600, the reverse procedure to the one just described can be done. Firstly, the battery handling mechanism 300 can direct the grabber element 350 holding a battery 400 towards the station battery holder 600 such that the battery 400 can occupy the cavity of the station battery holder 600. At the same time, the electrical pins 420 of the battery 400 can be inserted into the corresponding holes on the station battery holder 600, establishing the electric connection between them. Then, the grabber element 350 can lock the battery 400 to the station battery holder 600 with the help of the grabbing grippers 355. This can be done by moving the fixing unit 410 of the battery 400 towards the latches 610 of the station battery holder 600. The battery 400 can be locked in the station battery holder 600 if the fixing unit 410 is moved a predefined distance towards the latches 610, that is when the grabbing grippers 355 have reached a specific locking position. The battery grabber element 350 can be configured so that if the grabbing grippers 355 have reached said specific locking position, a locking feedback signal is generated and communicated to the controllers of station 10. When such a feedback signal is processed by the controllers of station 10, station 10 can confirm that the grabbing element 350 was able to successfully lock the battery 400 to the station battery holder 600 (see FIGS. 3C and 3D for embodiments of the grabber element 350 configured to provide feedback signal when it releases the battery 400 from itself). Having loaded the battery 400 successfully in the station battery holder 600, the grabber 350 can release the battery 400 and the battery handling mechanism 300 can move the grabber 350 away from the battery 400 Similar loading procedure can also be done for loading a battery 400 to the robot battery holder 602.

In FIG. 3B, another embodiment of the station battery holder 600, referred to as 600A, is shown. The robot battery holder 602A comprise similar or corresponding elements as the station battery holder 600A. For this reason, an explicit figure for both the station battery holder 600A and the robot battery holder 602A is not shown. Thus, in this and the following paragraph whenever referring to station battery holder 600A, reference to robot battery holder 602A should be implied. Station battery holder 600A comprises different fixing elements compared to the embodiment shown in FIG. 3A. The station battery holder 600A can comprise latches 710 that extend from the body of the station battery holder 600A. Latches 710 can assume an open position, allowing the battery to move freely in the station battery holder 600A, or a closed position keeping the battery fixed to the station battery holder 600A. Preferably, the station battery holder 600A can comprise a plurality of latches 710. The battery body 402 of the battery 400A can comprise fixing unit 410A adapted such that the latches 710 of the station battery holder 600A can be attached to keep the battery 400A fixed in the station battery holder 600A. Preferably, the battery 400A comprises a plurality of fixing unit 410A, symmetric to the latches 710 of the station battery holder 600A. Fixing unit 410A can be a plurality of holes in the battery body 402 of the battery 400A such that the latches 710 of the station battery holder 600A can be inserted into the holes 410A of the battery 400A.

In the embodiment of FIG. 3B, the battery grabber element 350B can comprises a plurality of grippers 755, symmetric to the latches 710 of station battery holder 600A. To load the battery 400A the grabber 350B can open the latches 710, allowing the battery 400A to be inserted into the station battery holder 600A. Then, the grabber 350B can load the battery 400A into the station battery holder 600A such that the latches 710 can be inserted in the holes 410A of the battery 400A. To unload the battery 400A from the station battery holder 600A, a similar process can be done. First, the grabber 350B can position its grippers 755 between the latches 710A and the holes 410A, then it can proceed by opening the latches 710, thus detaching the battery 400A from the latches 710. At this moment, the battery 400A can be pulled out of the station battery holder 600.

In FIG. 3C, a detailed view of an embodiment of a battery grabber element 350 is depicted. The battery grabber element 350 depicted herein, is configured to provide feedback signals when it successfully grabs or releases a battery 400.

As already discussed, (e.g. in FIG. 3A) the battery grabber element 350 can comprise a battery grabber element frame 353. Said battery grabber element frame 353 can be configured to provide support to the structure of the grabber element 350. Additionally, the battery grabber element frame 353 can be configured to attach the grabber element 350 to the battery handling mechanism, as well as attach or assemble the parts of the battery grabber element 350. That is, attached to the battery grabber element frame 353 the grabbing grippers 355 can be provided. Through the grabbing gripper 355 the grabber element 350 can grab the battery 400 and displace it.

Additionally, attached to battery grabber element frame 353 the grabber element 350 can comprise a battery presence detector 359. The battery presence detector 359 can be configured to provide a feedback when the battery 400 is attached to or grabbed by the battery grabber element 350. Vis-à-vis the presence detector 359 can be configured to provide feedback if the battery 400 is not attached to or grabbed by the battery grabber element 350. Such feedback may facilitate or improve the operation of the grabber element 350 and in general of the station 10.

The battery presence detector 359 can comprise a battery presence detector frame 3593, for simplicity also referred as frame 3593 (not to be confused with the battery grabber element frame 353). Said frame 3593 of the battery presence detector 359 can be configured to attach or secure the battery presence detector 359 on the battery grabber element 350, such as on the battery grabber element frame 353. For example, the frame 3593 of battery presence detector 359 can be screwed on the battery grabber element frame 353.

Additionally, flexibly connected to the frame 3593 of the battery presence detector 359 a switch cover 3594 can be provided to the battery presence detector 359. The flexible connection between the frame 3593 of the battery presence detector 359 and the switch cover 3594 can be realized by the flexible attachments 3592 which can also be referred as buckled elastic rods 3592. As depicted in FIG. 3C, four flexible attachment 3592 can attach the switch cover 3594 with frame 3593 through four different corners of the switch cover 3594. The flexible attachments 3592, like strings, can keep the switch cover “hanging” on the frame 3593. Thus, the switch cover 3594 can move, “up and down” in a direction perpendicular to the frame battery grabber element 353.

Below or covered by the switch cover 3594, at least one switch (not shown) can be placed, such as two switches. Hence, the allowed movement of the switch cover 3594 can activate and deactivate the switch, e.g. by pressing or releasing a button. That is, the allowed movement of the switch cover 3594, provided by the flexible attachment 3592, can allow the switch cover 3594 to assume or move between at least two positions, wherein in one of the positions the switch cover 3594 can contact and preferably apply a force on the switch below it and on the other position the switch cover 3594 may not contact the switch covered by it and/or the pressure applied on the switch may be lower (as compared to the first position). The switch can be configured to open and close a circuit, that can be connected to the controller of the station 10. Hence, it can be known, e.g. by the controller of station 10 and/or an operator, that the switch covered by the switch cover 3594 is closed or opened.

Thus, when the grabber element 350 grabs the battery 400 it can lie on the battery grabber element frame 353 and can contact the switch cover 3594. Furthermore, the weight of the battery 400 can move the switch cover 3594 toward the battery grabber element frame 353, hence pressing toward the at least one switch positioned therein between the battery grabber element frame 353 and switch cover 3594. This can cause the at least one switch to change its state (e.g. from a closed state to an open state or vice-versa), which change of state can be captured and recognized by the controller of station 10. Hence, upon a successful grabbing of the battery 400 a feedback signal can be produced by the battery presence detector 359 announcing to a processor unit or the controller of station 10 that the battery 400 is successfully grabbed.

Similarly, when the battery 400 is released from the battery grabber element 350 the pressure on the switch cover 3594 pressing it towards the battery grabber element frame 353 can reduce. This can cause the switch beneath the switch cover 3594 to change its state, hence announcing to the controller of station 10 that the battery 400 is released from the battery grabber element 350 and that the battery 400 is not anymore supported or grabbed by the grabber element 350.

In FIG. 3D yet another embodiment of a battery grabber element 350 comprising a battery presence detector 359 is depicted. In this embodiment, the battery presence detector 359 can be provided between the grippers 355 of the grabber element 350. In FIG. 3D, only one battery presence detector 359 is depicted, however, the grabber element 350 can be provided with multiple battery presence detectors 359. For example, another battery presence detector can be provided between the other pair of grippers 355 of the battery grabber element 350.

In a similar manner as discussed with respect to the embodiment of FIG. 3C, the battery presence detector 359, depicted in FIG. 3D, can be flexibly attached to the battery grabber element frame 353. The flexible connection with the battery grabber element frame 353 can allow the battery presence detector 359 to move “up and down” in the direction perpendicular to the battery grabber element frame 353. Thus, the battery presence detector 359 can be contacted and pressed by the battery 400, when the grabber element 350 grabs the battery 400. Battery 400 pressing on the battery presence detector 359 can change the state of a switch (not shown) comprised by the battery presence detector 359. The state change of the switch can be recognized by the controller of the station 10, hence indicating the grabbing of the battery 400 by the grabber element 350. Similarly, when the battery 400 is released from the grabber element 350, pressure on the battery grabber element 359 can be reduced, allowing the battery presence detector 359 to return to its normal position, which in turn changes the state of the switch comprised by the battery presence detector 359. This can allow the controller 10 to check if the battery is released or grabbed by the grabber element 350.

In the preceding paragraphs, a limited number of embodiments of the battery 400, the station battery holder 600 and the battery grabber element 350 are illustrated. It is valuable to notice, that different embodiments of the battery 400, the station battery holder 600 and the battery grabber element 350 can be used with the station 10. Furthermore, the embodiments of the battery 400, the station battery holder 600 and the grabber 350 can be combined in different ways to provide different embodiments of the station 10. In the following paragraphs whenever referring to station battery holder 600 with the corresponding battery embodiment 400 and corresponding battery grabber element embodiment 350 with their corresponding elements, reference to the station battery holder 600A with the corresponding battery embodiment 400A and corresponding battery grabber element embodiment 350B with their corresponding elements should be implied and whenever referring to the robot battery holder 602 with the corresponding battery embodiment 400 and corresponding battery grabber element embodiment 350 with their corresponding elements, reference to the robot battery holder 602A corresponding battery embodiment 400A and corresponding battery grabber element embodiment 350B with their corresponding elements should be implied. In other words, whenever referring to the embodiments depicted in FIG. 3A reference to the embodiments depicted in FIG. 3B or FIG. 3C should be implied, unless otherwise clarified by the context.

Referring now to FIG. 4A, an embodiment of the battery handling mechanism 300, which may also be referred to as handling mechanism 300, is shown. As described in the preceding paragraphs, the handling mechanism 300 can be adapted to position the grabber element 350 in a specific location p (x, y, z) within its reaching range. During loading and/or unloading of the batteries 400 from the station battery holder 600, or the robot battery holder 602, the controller unit of the station 10 can provide the coordinates of the battery 400 load or unload location to the handling mechanism 300. The battery load/unload location can be the location where the handling mechanism 300 should load or unload the battery 400, such as the station battery holder 600 or the robot battery holder 602. The handling mechanism 300 can be adapted to position the grabber element 350 at the specified coordinates.

The handling mechanism 300 can comprise a base 303, referred to as battery handling mechanism frame 303. The battery handling mechanism frame 303 of the handling mechanism 300 can be fixed in the base of the station 10 (refer to FIG. 1B). At least one linear shaft 305 can be attached to the battery handling mechanism frame 303. In a preferred embodiment, a plurality of parallel linear shafts 305 can be attached to the battery handling mechanism frame 303, such as two parallel linear shafts 305. Linear shafts 305 can be adapted to facilitate the movement of the grabber element 350, by guiding the grabber element 350, in the direction of the x-axis (with reference to the coordinative system given in FIG. 1B). In a preferred embodiment, the linear shafts 305 can comprise elongated metallic rods 305 adapted to comprise a smooth outer surface, such as, for example, high carbon chromium steel. The length of the linear shafts 305 can be adapted such that the handling mechanism 300 can position the grabber element 350, according to the x-direction, at each of the charging units 132 of the station 10, as well as at the surface opening 109. The diameter and/or strength of the linear shafts 305 can be adapted to support the weight of the grabber element 350 and of the batteries 400.

Further, the battery handling mechanism 300 can comprise at least one x-axis actuator 307. The x-axis actuator 307 can be adapted to move the grabber element 350 in the x-direction (with reference to the coordinate system given in FIG. 1B). In one embodiment, the x-axis actuator 307 can comprise a motor 309. The motor 309 can be controlled so as to produce predefined linear movements of the grabber element 350 in the x-direction. For example, the controllers of the station 10 can signal the motor 309 to move x₁ cm on the x-axis, wherein x₁ can be any number from 0 to the maximum reaching range of the x-axis actuator. In a preferred embodiment, motor 309 can be a stepper motor 309. The x-axis actuator 307 can be a hydraulic actuator, pneumatic actuator, electrical actuator, magnetic actuator, or a mechanical actuator, electro-mechanical actuator, etc. In a preferred embodiment, the x-axis actuator 307 can be an electrical-mechanical actuator 307, such as a traveling-nut actuator with fixed nut and roller screw, a traveling-nut actuator with fixed screw and roller nut, rack and pinion actuator, etc. It should be noted that in this paragraph only some exemplary embodiments of actuator types for the x-axis actuator 307, are provided. Other actuators can also be adapted to be used by the battery handling mechanism 300 of the station 10.

It should be noted that, throughout the text, the coordinate system depicted in FIG. 1B should be taken as a reference coordinate system unless otherwise implied by the context.

The grabber element 350 can be attached to the linear shafts 305 and/or to the x-direction actuator 307, by means of horizontal frames 310 and lifting mechanism 325. The horizontal frames 310 can comprise move smoothing elements 312. The move smoothing elements 312 can be placed in the vicinity of the connection points between the horizontal frames 310 and the linear shafts 305. The move smoothing elements 312 can be adapted to decrease the friction between the horizontal frame 310 and the linear shafts 305, resulting in a smooth linear movement of grabber element 350 along the linear shafts 305. In a preferred embodiment, the move smoothing elements 312 comprise at least one linear bearing 312. The diameter of linear bearing 312 can be in accordance with the diameter of the linear shafts 305.

The lifting mechanism 325, in the embodiment shown in FIG. 4A, can be adapted to guide the movement of the grabber element 350 in the z-direction. In the embodiment depicted in FIG. 4A, the lifting mechanism 325 can be configured as a scissor lift mechanism 325. The lifting mechanism 325, as shown in the embodiment of FIG. 4A, can comprise two elongated structures 337 forming an “X” shape and/or can be formed like a scissor lift. The elongated structures 337 can be adapted to facilitate the movement of the grabber element in the z-direction. The elongated structures 337 can be further adapted to provide extra support for the lifting mechanism 325 to hold the grabber element 350 and/or the battery 400. The lifting mechanism 325 can be attached to the horizontal frame 310 and to the grabber element 350 by means of rotational joints. Further, the two elongated structures 337 of the lifting mechanism 325 can be attached to each other by means of rotational joints. These joints can be adapted to allow the grabber element 350 to assume any position on the z-axis within the reaching range of the handling mechanism 300.

The movement of the grabber element 350, in the z-direction can be produced by the z-axis actuator 327. In one embodiment, the z-axis actuator 329 can comprise a motor 329. The motor 329 can be controlled so as to produce predefined linear movements of the grabber element 350 in the z-direction. For example, the controllers of the station 10 can signal to the motor 329 to move z₁ cm on the z-axis, wherein z₁ can be any number from 0 to the maximum reaching range of the z-axis actuator. In a preferred embodiment, motor 329 can be a stepper motor 329. The z-axis actuator 327 can be a hydraulic actuator, pneumatic actuator, electrical actuator, magnetic actuator, and/or a mechanical actuator, electro-mechanical actuator, etc. In a preferred embodiment, the z-axis actuator 327 can be an electrical-mechanical actuator 327, such as a traveling-nut actuator with fixed nut and roller screw, a traveling-nut actuator with fixed screw and roller nut, rack and pinion actuator, etc. It should be noted that in this paragraph only some exemplary embodiments of actuator types for the z-axis actuator 327, are provided. Other actuators can also be adapted to be used by the battery handling mechanism 300 of the station 10.

Referring now to FIG. 4B and FIG. 4C, another embodiment of the lifting mechanism referred to with numeral 325A is shown. In the embodiment depicted in FIG. 4B and FIG. 4C, the lifting mechanism 325A can be configured as a parallelogram lift 325. The lifting mechanism 325A comprises a base frame 344. The base frame 344 can be adapted to attach the lifting mechanism 325A to the linear shafts 305 by means of move smoothing elements 312 (not shown here) that can be similar to the ones described with reference to FIG. 4A. The grabber element 350A (refer to FIG. 4C) can be attached to the base frame 344 by the guiding lifting elements 337A. The guiding lifting elements 337A can be adapted to facilitate the movement of the grabber element in the z-direction. The guiding lifting elements 337A can be further adapted to provide extra support for the lifting mechanism 325A to hold the grabber element 350A and/or the battery 400. In a preferred embodiment, the lifting mechanism 325A comprises a plurality of guiding lifting elements 337A. The guiding lifting elements 337A can be separated into two pairs, wherein each pair can be attached to one of the two sides of the grabber 350A parallel to the plane (x, z), as depicted in FIG. 4A. The guiding lifting elements 337A can be attached to the grabber element 350A by means of rotational joints 341.

Further, the lifting mechanism 325A can comprise a z-axis actuator 327A. The z-axis actuator 327A can be a hydraulic actuator, pneumatic actuator, electrical actuator, magnetic actuator, or a mechanical actuator, electro-mechanical actuators, etc. In a preferred embodiment, the z-axis actuator 327A can be an electrical-mechanical actuator 327A, such as a traveling-nut actuator with fixed nut and roller screw, a traveling-nut actuator with fixed screw and roller nut, rack and pinion actuator, etc. It should be noted that in this paragraph only some exemplary embodiments of actuator types for the z-axis actuator 327A, are provided.

In the depicted embodiment of FIG. 4B said z-axis actuator 327A can be configured as a traveling-nut actuator 327A comprising at least one screw metallic rod and one motor 329A, preferably a stepper motor 329A. The motor 329A can be controlled such as to produce predefined linear movements of the grabber element 350A in the z-direction. The z-axis actuator 327A can act on the grabber element 350A with a force parallel to the z-direction. While loading, or unloading a battery 400, the grabber element 350A can move in parallel with the z-direction. In other words, the lifting mechanism 325A can produce movement of the grabber 350 along the z-axis only. However, the torque generated by the z-axis actuator 327A can produce movement in the z-direction and x-direction at the same time. Thus, it can be advantageous that the x-direction movement be nulled. To accomplish this, the x-axis actuator 307 (refer to FIG. 4A) can compensate the x-direction movement produced by the torque of the z-axis actuator 327A. So, suppose the z-axis actuator 327A can rotate the grabber 350 by an angle α with respect to the base frame 344 and suppose that the length of guiding lifting elements 337A is l. This can mean that the grabber 350 can move a distance (l·sin α) along the z-direction and (l·cos α) along the x-direction. For keeping a constant position in the x-direction while lifting the grabber 350, the x-axis actuator 307 can simultaneously move (−l·cos α), while the z-axis actuator 327A can rotate the grabber 350 by an angle α. Thus, the movement in the x-direction can be compensated for, while the movement in the z-direction can be (l·sin α).

In FIG. 4D, a schematic view of a localization element 343 according to an embodiment is shown. The localization elements 343 can be implemented in the station 10. In an embodiment, the localization elements 343 can be implemented directly in or on the surface of station 10, facing the bottom of the mobile robot 20. The localization element can be placed on or in the station body 101. In another embodiment, the localization elements 343 may be implemented in the handling mechanism 300, preferably in the battery grabber 350 of the handling mechanism 300. In the embodiment depicted in FIG. 4B, FIG. 4C, the localization element 343 can be implemented in the battery grabber element 350A. In an embodiment, the localization element 343 can be configured to detect the presence of at least one localization target 700 in its sensing range 515. In another embodiment, the localization element 343 can be configured to locate at least one localization target 700 in its sensing range 515. In yet another embodiment, the localization element 343 can be configured to detect and locate at least one localization target 700 in a reaching range of the grabber element 350.

The localization target 700 can be any object that can be positioned in the sensing range 515 and that can be detected and/or located by the localization target 343. In an embodiment, the localization target 700 can be the battery 400. That is, in such embodiments, the localization element 343 can be configured to at least one of detect and locate the battery 400, when the battery 400 is in the sensing range 515. In a specific example, the localization element can be configured to at least one of detect and locate the battery 400 of the mobile robot 20, when the mobile robot 20 is in the battery load/unload position 115. In another embodiment, the localization target can be the mobile robot 20. That is, in such embodiments, the localization element 343, can be configured to at least one of detect and locate a mobile robot 20, when the mobile robot 20 is in the sensing range 515. In a specific example, the localization element 343 can detect and locate a mobile robot 20, when the mobile robot 20 is positioned in the battery load/unload position 115. In yet another embodiment, the localization target 700 can be both the battery 400 and the mobile robot 20. In some embodiments, the localization target 700 can comprise any of the battery 400, mobile robot 20, part of mobile robot 20 surrounding the battery 400, the battery charging unit 132, the station battery holder 600, the robot battery holder 602.

The localization elements 343 may comprise at least one sensor device 510, that can also be referred to as sensor 510, preferably a plurality of sensors 510 adapted to sense the localization target 700, when said localization target 700 is positioned within the sensing range 515 of said sensors 510. The sensor device 510 can be configured to emit electromagnetic waves. Such electromagnetic waves can comprise a non-negligible energy or a non-negligible amplitude in the sensing range 515. That is, the sensing range 515 can be the zone in the vicinity of the sensor device 510, wherein the electromagnetic waves emitted by the sensor 510 can comprise a non-negligible energy or amplitude. The sensor device 510 can be configured to detect changes in the emitted electromagnetic waves in the sensing range 515. That is, the sensing range 515 can be the zone in the vicinity of sensor 510, wherein the sensor 510 can be capable of detecting changes in the electromagnetic field the sensor 510 creates. Outside the sensing range 515, the sensor 510 cannot detect the changes in the electromagnetic field it creates. The volume of the sensing range 515 can depend on the type of the senor device 510 that can be used. Different sensor 510 types and technologies comprise different sensing range. It can be advantageous and desirable that such a sensing range be maximized. In a specific example, the sensing range 515 can have dimensions, such that when the mobile robot 20 is positioned in the battery load/unload position 115, the at least one of mobile robot 20 and battery 400 of the mobile robot 20 is positioned within the sensing range 515.

The sensor device 515 can detect the presence of the localization target 700 in the sensing range 515 by continuously, such as periodically, emitting electromagnetic waves in the sensing range 515 and being able to detect changes in the electromagnetic field in the sensing range 515. Such changes in the electromagnetic field can be caused by the presence of the localization target 700 in the sensing range 515.

In an embodiment, the sensor device 510 can be an inductive sensor 510. In such an embodiment, the presence of a conductive material in the sensing range 515 can cause changes in the electromagnetic field created by the inductive sensor 515.

Thus, the localization target 700 can be a conductive material surrounding or being surrounded by a non-conductive material, or the localization target 700 can be a non-conductive material surrounding or being surrounded by a conductive material. In a specific example, the battery 400 can comprise a non-conductive material while the part of the mobile robot 20 surrounding the battery 400, such as the bottom of the mobile robot 20, can comprise a conductive material such as a metal sheet like aluminum, or composite material like plastic coated with aluminum. A specific inductive sensor 515 can detect a localization target 700 as follows. An oscillating current, such as AC current, that can flow through an inductor (part of localization element 343) can generate an oscillating magnetic field, such as AC magnetic field. If a conductive material, such as a metal object, is brought into the vicinity of the inductor within the sensing range 515, the magnetic field will induce a circulating current (Eddy Current) on the surface of the conductor. The resistance and inductance of induced current caused by the Eddy current can be modeled as a distance dependent resistive and inductive component on the localization element 343. Thus, the localization element can detect the presence of a conductive material in the sensing range 515 of the localization element 343.

In another embodiment, the sensor device 510 can be a capacitive sensor 510. In such an embodiment, the presence of a localization target 700 in the sensing range 515 can cause changes in the electromagnetic field created by the capacitive sensor 510. In such embodiments, the localization target 700 can comprise any material and can be surrounded by or surrounding a different material.

In another embodiment, the sensor device 510 can be configured as a radar 510. That is, the radar 510 can be configured to emit electromagnetic waves and receive the electromagnetic waves reflected by a localization target 700 within the sensing range 515. In such embodiments, the localization target 700 can be a conductive material surrounded by or surrounding a non-conductive material, or the localization target 700 can be a non-conductive material surrounded by or surrounding a conductive material. In a specific example, the battery 400 can comprise a non-conductive material, while the part of the mobile robot 20 surrounding the battery 400, such as the bottom of the mobile robot 20, can comprise a conductive material such as a metal sheet like aluminum, or composite material, such as plastic coated with aluminum. In such an example, the radar 510 can emit electromagnetic waves towards the battery 400 and the bottom of the mobile robot 20, when the mobile robot 20 is in the battery load/unload position 115, i.e. the battery 400 and the bottom of the mobile robot 20 can be in the sensing range 515. The bottom of the mobile robot 20, comprising a conductive material, can reflect the electromagnetic waves emitted by the radar 510. The battery 400, comprising a non-conductive material, cannot reflect the electromagnetic waves, or the reflected electromagnetic waves by the battery 400 can comprise a negligible amplitude or energy. Thus, the radar can detect the presence or the non-presence of the localization target 700 in the sensing range by emitting and receiving electromagnetic waves.

Further, the localization element 343 can comprise a processor unit 505. The processor unit 505 can be configured to receive the sensor 510 readings and process them to at least one of detect and locate the localization target 700. The processor unit 505 can be part of the controller circuitry of the battery station 10 or can be a separate processor unit connected to the sensor device 510.

The localization element 343 can be configured to locate a localization target 700. That is, the localization element 343 can find the position of the localization target 700. The localization element 343 can be configured to find at least one of the spatial coordinates of the localization target 700 with reference to a coordinate system, such as the one depicted in FIG. 1B. In an embodiment, the localization target 343 can scan the space in the vicinity of the localization target including the localization target. While scanning, the processor unit 505 can keep track of the sensors' 510 position. The readings from the sensors can be used to decide whether the localization target 700 is sensed or not. Thus, by sensing the localization target 700 and keeping track of the position of the sensor 510, the localization target 700 can be located. In a specific example, the localization element 343 can scan the bottom of the mobile robot 20. After the scanning, the position of the mobile robot 20 can be found. The processor unit 505 can know where the battery 400 is positioned in the mobile robot 20. Thus, by having found the position of the mobile robot 20 and knowing were the battery 400 is in the mobile robot 20, the position of the battery 400 can be calculated. In another example, the localization element 343 can directly find the location of the battery 400.

FIG. 4E depicts another embodiment of the localization element 343. FIG. 4E depicts a view from the top of the station 10, with the cover element 110 slid over the surface of station 10, thus opening or uncovering the top opening 109. The top opening 109 can allow the battery lifting mechanism 325 and the battery grabber element 350 to be seen in the depicted view. Other elements of station 10, that may be normally visible through the top opening 109, are not depicted in FIG. 4E, such that the figure is not overloaded.

As it can be noticed, the localization element 343 can be placed near the grippers 355 of the grabbing element 350. For example, the localization element 343 can be fixated on the structure of the lifting mechanism 325, close to the grippers 355, having a view towards the top opening 109 of station 10. This can allow the localization element 343 to sense the region through the top opening 109 of station 10, hence facilitating localization of the battery 400 of a mobile robot 10 positioned in the battery load/unload position 115.

The localization element 343 can comprise a camera 343. Camera 343 can be connected to a processor unit (not shown) or to the controller of the station 10. For example, camera 343 can be connected with a processor unit and/or the controller of station 10 through the wired connection 3434. The camera 343, placed facing the top opening 109, can capture at least one image, preferably a plurality of images, of the view allowed by the top opening 109 (when the cover element 110 is in the open position). As discussed, when a mobile robot 10 is positioned in the battery load/unload position 115, its battery or batteries 400 can be aligned with the top opening 109. Thus, the camera 343 can capture at least one image of the battery 400 of the mobile robot 10.

The images captured by camera 343 can be stored in a memory and provided to a processing unit, e.g. to the controller of station 10. The processing unit can process the images captured by the camera 343. The algorithm executed to process images captured by camera 343 can be configured to detect the presence and position of battery 400 on the at least one captured image. For example, the algorithm can compare the captured images by the camera 343 with training images, said training images comprising images of the battery 400, preferably from different viewing angles and/or light conditions and preferably images of the side of battery 400 that normally faces the camera 343.

Thus, using images captured by camera 343 (or localization element 343) the position of the battery 400 relative to the station 10 and/or battery grabber element 350 and/or with reference to a coordinate system can be inferred. Information regarding position of the battery 400 can facilitate the process of grabbing the battery 400.

In a similar manner, the camera 343 can capture images of the robot battery holder 602 and can be configured to localize it. This can facilitate the loading of a battery 400 in the robot battery holder 602.

In addition, at least one light source 3432, such as a strip of LED lights 3432, flashes etc., can be provided near the camera 343, preferably facing the top opening 109. The light source 3432 can improve the light conditions around camera 343, e.g. can illuminate the battery 400. Thus, the light source 3432 can improve the quality of images captured by camera 343, which can contribute on better results for localizing the battery 400 and/or the battery holder 602.

Localization of the battery 400 by the camera 343 can be facilitated by a recognizable pattern 3436 provided in the battery 400, more particularly on the side of battery 400 that can be “seen” by camera 343, as depicted in FIG. 4F. The recognizable pattern 3436 can comprise distinctive features, such as, distinctive colors, as compared to the battery 400 and/or the surrounding. Thus, on the images captured by the camera 343 the recognizable pattern 3436 can be detected automatically by a processor unit processing the images. Though, in FIG. 4F the recognizable pattern is depicted as a regular rectangular pattern, in general it can be any distinctive pattern which can be easily (or easier) to detect on an image captured by the camera 343.

The recognizable pattern 3436 can make the detection of the battery 400 faster, as it can be easier to detect the recognizable pattern 3436 as compared, for example, to detecting the battery 400. For example, on the images captured by the camera 343 the edges separating the battery 400 from the background or rest of the image may be less visible than the edges separating the recognizable pattern 3436 from the rest of the image. Thus, it can be easier and faster for a processing unit to detect the recognizable pattern 3436 Similarly, the recognizable pattern 3436 can be detected and localized with higher precision as compared to localizing the battery 400 without the recognizable pattern 3436, hence improving the accuracy of localizing the battery 400.

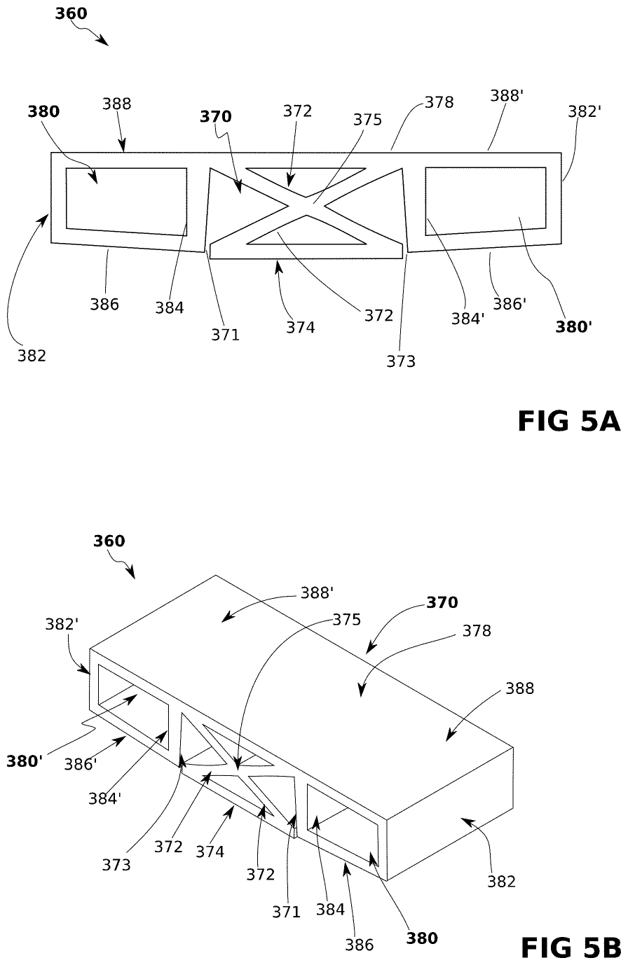

As shown in FIG. 4C, the grabber element 350A can further comprise a plurality of grippers 355, such as four grippers 355. The grippers 355 can be attached to the grabber element 350A by means of a flexural joint 360. The flexural joint 360 can allow the grippers 355 to adapt to horizontal misalignments of the battery 400. For example, due to some obstacles like snow, stones, dust, mud etc., stuck to the wheels 806 (see FIG. 7A) of the robot 20, the bottom surface of the robot 20 may not be parallel to the grabber element 350A, which can cause possible misalignment between the grabber element 350A and the battery 400. In another example, a downward force due to the weight of the battery 400 can be applied on the grabber element 350A, when the battery grabber element 350A can support the battery 400. Due to possible misalignments, this force can be unequally distributed on the grippers of the grabber element 350A, more particularly on the grippers 355. Thus, a bigger downward force due to the weight of the battery 400 can be applied on some of the grippers 355 than on the other grippers 355. The same unequal distribution of forces can be applied on the battery 400, due to the counterforce associated with each force, wherein some parts of the battery 400 can suffer a bigger force than other parts of the battery 400. In yet another case, possible vibrations of the grabber element can occur while the battery handling mechanism 300 moves the grabber element 350A. These vibrations can also be produced by the possible movements of the station 10, or by other similar external effects. In a case where the battery grabber element 350 can loaded with a battery 400, said vibrations can also be transmitted to the battery 400. Such situations can damage the structure of the grippers 355, the battery grabber element 350A and/or the battery 400. Thus, to deal with such hazardous situations, the grippers 355 can be attached to the battery grabber element 350A by means of the flexural joint 360. Referring to FIG. 5A and FIG. 5B an embodiment of the flexural joint 360 is shown. The flexural joint 360 can be an element adapted to join two or more other elements, e.g. the flexural joint 360 can be adapted to join the gripper 355 to the grabber element 350A. Further, the flexural joint 360 can be adapted to allow certain motion by bending in certain directions, e.g. due to possible hazard situations discussed in the preceding paragraph, the flexural joint 360 can bend at certain parts that can be attached to the grippers 355 experiencing a larger force due to the unequal distribution of the weight of the battery 400. The bending of the flexural joint 360, at certain parts of it, can be proportional to the force applied on those respective parts, i.e. the grippers 355 experiencing a bigger force can bend part of the attachment with the flexural joint 360 more than the grippers 355 experiencing a weaker force. This feature of the flexural joint 360 can equalize the distribution of weight of the battery 400 over the grippers 355, thus overcoming the hazard situations related to possible misalignment of the battery 400 with the grabber element 350.

The movement of the flexural joint 360 can be made possible by deforming the material of the flexural joint 360. The flexural joint 360 can comprise flexible material. The flexural joint 360 can be made out of one piece of material. In a preferred embodiment, the flexural joint 360 can comprise a material that can repeatedly bend, to a certain bend level, without disintegrating. In a preferred embodiment, the flexural joint 360, can be manufactured using 3D printing technology.

Referring to FIG. 54 and FIG. 5B a preferred embodiment of the flexural joint 360 is depicted. The flexural joint 360 can be adapted to join two or more other elements. Thus, the flexural joint 360 can comprise at least two mounting points, preferably a plurality of mounting points, adapted to attach the other elements to the flexural joint 360. In the embodiment depicted in FIG. 5A and FIG. 5B the flexural joint comprises three mounting two of them positioned at the first mounting sides 382 and 382′ and the other one positioned at the mounting base 374. Thus, in such an embodiment, the flexural joint 360 can be adapted to join three elements to each other. In another embodiment, the flexural joint 360 can have another mounting point on the top side 378 of flexural joint 360. In another embodiment, the flexural joint 360 can have at least one mounting point positioned at any of the elements 382, 382′, 374 and/or 378.

In an embodiment, the flexural joint 360 can be configured as a cartwheel hinge 370 (refer only to element 370 in FIG. 5A and FIG. 5B). The cartwheel hinge 370 can comprise two elastic elongated elements 372, which can also be referred to as leaves 372. The leaves 372 can be intersected with each other in the pivot point 375. In a preferred embodiment, the pivot point 375 can be in the middle of the leaves 372. The base 374, connecting the ends of the leaves 372 as depicted in FIG. 5A and FIG. 5B, can be left free, i.e. it cannot be connected to the first limiting wall 371 and/or second limiting wall 373. Such a structure can allow the base 374 to rotate with respect to the pivot point 375. Said rotation can be made possible by the bending of the leaves 372. This rotation can be limited by the first limiting walls 371 and/or by the second limiting wall 373. The distance between the first limiting wall 371 and/or second limiting wall 373 from the mounting base 374, can be chosen such that the maximum rotation of the mounting base 374, allowed by the first limiting wall 371 and/or second limiting wall 373, does not break the leaves 372. The more flexible the material of the leaves 372, the bigger the allowed rotation of the base 374, the more the flexibility offered by the cartwheel hinge 370.

In another embodiment, the flexural joint 360 can be configured as a parallelogram flexure 380 (refer only to element 380 in FIG. 5A and FIG. 5B). The parallelogram flexure 380 can comprise two vertical sides and two horizontal sides creating a parallelogram-like shape. In the depicted embodiment, the parallelogram flexure 380, comprises a first mounting side 382 and a second mounting side 384. The parallelogram flexure can further comprise a first elastic arm 386 and a second elastic arm 388. The second mounting side 384 and the first mounting side 382 can be connected by the first elastic arm 386 and or the second elastic arm 388 forming a parallelogram structure. In a preferred embodiment, the parallelogram flexure 380 can be configured to join at least two other elements, by mounting them on the first mounting side 382 and/or the second mounting side 384. In a situation, wherein a force is applied on the first mounting side 382, i.e. the force can be applied by the element mounted on first mounting side 382, and the second mounting side 384 is kept fixed, i.e. it is mounted to a fixed non-movable object, then the second elastic arm 388 and the first elastic arm 386 will bend on the direction of the applied force, allowing the first mounting side to move in the direction of the applied force. Similar situation can happen when a force is applied on the second mounting side 384 and the first mounting side 382 is kept fixed, or when both the first mounting side 382 and the second mounting side 384 are not fixed.

In a preferred embodiment, the first elastic arm 386 and the second elastic arm 388 are thinner than the second mounting side 384 and the first mounting side 384. In a preferred embodiment, the ratios between the thickness of the second mounting side 384, first mounting side 382, second elastic arm 388, first elastic arm 386 can be as follows:

$$\frac{Thickness of the first mounting side 382}{Thicknes of the second mounting side 381}$$

can be in the range of 0.20 to 5.00, more preferably 0.80 to 1.25, such as 1.0.

$$\frac{Thickness of the second elastic arm 388}{Thickness of the first elastic arm 386}$$

can be in the range of 0.7 to 2, more preferably 0.80 to 1.25, such as 1.0.

$$\frac{Thickness of the first mounting side 382}{Thickness of the second elastic arm 388}$$

can be in the range of 1.0 to 10.0, more preferably 1.0 to 10.0, such as 3.0.

It should be noted the ratios given above relate to some preferred embodiments and are provided here for a deeper understanding of the structure of such embodiments of the parallelogram flexure 380. Such ratios and/or the sizes of the parallelogram flexure can be adapted based on the application of the parallelogram flexure. Such adaption is done based on the requirements of the application of the parallelogram flexure, i.e. for more flexibility but less supported weight the thickness of the second elastic arm 388 and/or the first elastic arm 386 can be reduced. For more supported weight but less flexibility the thickness of the of the second elastic arm 388 and/or the first elastic arm 386 can be increased. Furthermore, for more supported weight and/or stronger mounting points the thickness of the first mounting side 382 and/or the thickness of the second mounting side 384 can be increased and if less supported weight and/or weaker mounting points are required the thickness of the first mounting side 382 and/or the second mounting side 384 can be decreased. Such adaption means can be beneficial since they increase the range of application of such a flexure. This adaption can be facilitated further if 3D printing technology is used.

In a preferred embodiment, such as the one depicted in FIG. 5A and FIG. 59, the flexural joint 360 is configured as a combination of cartwheel hinge 370 and parallelogram flexure 380. The flexure joint 360 can comprise at least one of the following elements: cartwheel hinge 370, parallelogram flexure 380. In the depicted embodiment in FIG. 5A and FIG. 5B, the flexural joint 360 comprises one cartwheel hinge 370 and two parallelogram flexures 380 the left parallelogram flexure 380 and the right parallelogram flexure 380′. The left parallelogram flexure 380 and the right parallelogram flexure 380′ comprise similar structures. In an embodiment, the left parallelogram flexure 380 is attached to the cartwheel hinge 370 by mounting the second mounting side 384 of the left parallelogram flexure 380 with the first limiting wall 371 of the cartwheel hinge 370 and/or the right parallelogram flexure 380′ is attached to the cartwheel hinge 370 by mounting the second mounting side 384′ of the right parallelogram flexure 380′ with the second limiting wall 373 of the cartwheel hinge 370. In another preferred embodiment, the second mounting side 384 of the left parallelogram flexure 380 and the first limiting wall 371 can be the same element and/or the second mounting side 384′ of the right parallelogram flexure 380′ and the second limiting wall 373 can be the same element. In such embodiment, the flexural joint 360 is manufactured as one element, with no distinct separation between the parallelogram flexures 380 and/or the cartwheel hinges 370.

The combination of the parallelogram flexure 380 and the cartwheel hinge 370, increases the flexibility of the flexural joint 360. The flexural joint 360 can support more degrees of freedom with respect to flexibility. Vertical motion, up and down, can be allowed by the parallelogram flexure 380, and rotation motion, with respect to the pivot joint 375, can be allowed by the cartwheel hinge 370.

In a preferred embodiment, the flexural joint 360 can be adapted for use by a grabber element, such as the battery grabber element 350A, 350 and/or 350B of the station 10 (refer to FIG. 4C). In the depicted embodiment, the flexural joint 360, can be adapted to join two grippers 355 with the grabber element 350A. The flexural joint 360 can be attached to the body of the grabber element 350A through the mounting base 374. One gripper 355 can be attached on one of the mounting sides 382, 384, for example on the first mounting side 382 and/or another gripper 355 can be attached on the other mounting side, for example on the second mounting side 384. When force can be applied to the grippers 355, the flexural joint 360 can bend in certain direction as described in the preceding paragraph.

Throughout the document, different embodiments for the elements of station 10 were provided. In the provided figures, these embodiments of the elements of the station 10 were combined in certain manner. This combination is done only for illustrative purposes. The embodiments of the elements of station 10 can also be combined in different manners. Thus, all the combinations of such embodiments should be taken in consideration unless stated differently.

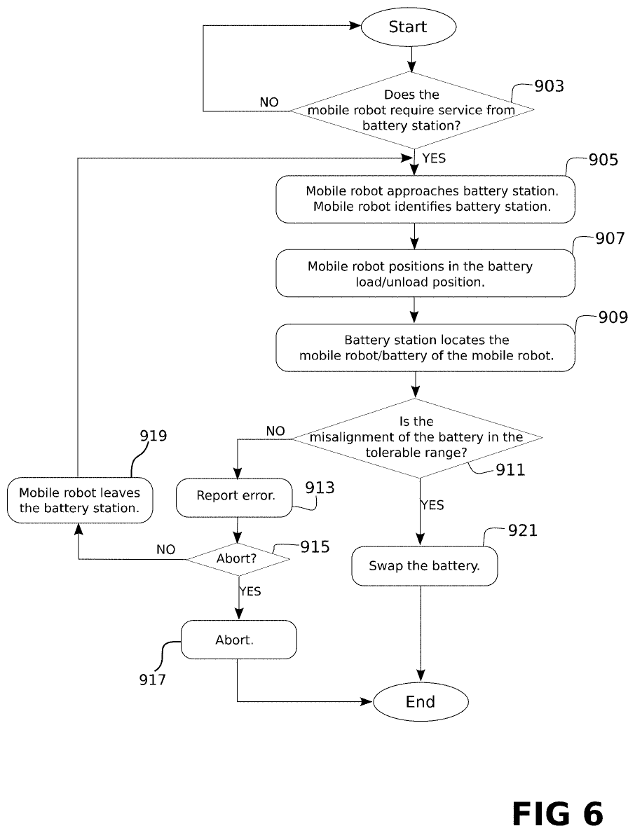

Referring to FIG. 6, a flowchart of a procedure of battery swapping according to an embodiment is shown. The procedure can start with step 903, wherein a mobile robot 20 requires service of station 10. In some embodiments, the mobile robot 20 can be configured to seek service from the at least one battery station 10 when the energy level of the at least one batteries 400 of the mobile robot 20 is below a certain threshold level. The threshold level can preferably be programmable onto the at least one robot 20. That is, while operating the mobile robot 20 can consume the energy stored in at least one of its batteries 400. Thus, the energy level of at least one of its batteries 400 can decrease. When the energy level of at least one of its batteries 400 is smaller or equal to a threshold level, it can be desirable for the mobile robot 20 to require a battery 400 which is storing an energy bigger than the threshold level. Thus, it can be desirable for the mobile robot 20 to seek service from the battery station. It can also be advantageous for the threshold level to be programmable on the mobile robot 20, so that it can easier adapt to cases when a different type of battery 400 is used, or to other conditions that affect the battery consumption by the mobile robot 20. In some embodiments, the mobile robot 20 can be configured to seek service from the at least one battery station 10 when the service life of the battery 400 is over. For example, the mobile robot 20 can seek service from the battery station 10 when at least one of its batteries 400 can be malfunctioning, have reached a predefined loss of capacity, which can be a fraction of the original capacity of the battery 400 when the battery 400 is produced, or when the battery 400 have reached its end of life. In some embodiments, the mobile robot 20 can be configured to seek service from the at least one battery station 10 when the battery is malfunctioning. For example, the battery 400 of the mobile robot 20 does not work properly. That is, the battery 400 of the mobile robot 20 cannot supply the required energy, power, voltage and/or current. In another example, the battery's contact points can be damaged. Thus, it can be advantageous for the mobile robot to seek service from the battery station, as the battery station can comprise batteries that work in a proper way.

In a next step 905, the mobile robot 20 can approach the battery station 10 if it requires service from a station 10. In an embodiment, the robot 20 can be provided the coordinates of the station 10 and it can approach in an autonomous or semi-autonomous way the station 10. In another embodiment, the mobile robot 20 may have a database containing the positions of at least the stations 10 positioned in the area the robot 20 operates. In another embodiment, the mobile robot 20, can be remotely controlled to approach the station 10. In a preferred embodiment, the robot 20 can approach the station 10 that is nearest to it. The mobile robot 20 can read or detect the identification element 107 of the battery station 10 so that the robot 20 can know at which battery station 10 it can have approached. The mobile robot 20 can read or detect the identification element 107 of the station 10, using the optical sensors and/or cameras 812 that the mobile robot 20 can comprise.

In a next step 907, the robot 20 can position itself to the battery load/unload position 115 by sensing the horizontal lines 105 (see FIG. 1A), using the optical sensors and/or cameras 812 (see FIG. 7A). That is, the guiding element 105 of the battery station 10 can facilitate the positioning of the mobile robot 20 in the battery load/unload position 115. When the mobile robot 20 can be positioned in the battery load/unload position 115, the battery 400, of the mobile robot 20 is aligned with the surface opening 109, to facilitate the operation of the battery handling mechanism 300 on the battery 400.

In a next step 909, the sensors of station 10 may indicate to the controller unit of station 10 that a mobile robot 20 is waiting in the battery load/unload position 115 for a battery swapping. Or such information can be transmitted to the controllers of station 10 by the mobile robot 20. In another embodiment, a server 90 (refer to FIG. 6C) may communicate to the battery station 10 that a mobile robot 20 is positioned in its battery load/unload position 115 waiting for its service. The controller unit of station 10 signals the handling mechanism 300 to initiate the localization of the discharged battery 400 positioned in the robot battery holder 602 of the mobile robot 20. A discharged battery 400 can be any battery 400 with any energy level from empty to not full.

The handling mechanism 300 can start by positioning the battery grabber 350 in the surface opening 109 (see FIG. 1C). Since the surface opening 109 can be a fixed element, i.e. its exact position can be known by the controller unit of station 10, the handling mechanism 300 can position the grabber 350 to the surface opening 109 by simply taking the exact coordinates of the surface opening 109 from the controller unit of station 10. Next step 909 can be to localize the discharged battery 400 positioned in the mobile robot 20. Since the range of error of the positioning of robot 20 in the battery load/unload position 115 can be larger than the misalignment that the mechanical parts of the grabber element 350 can tolerate, extra localization elements 343 can be required for grabbing the battery 400.

To illustrate this concept better, the following example is provided. For simplicity, denote the battery load/unload position 115 as being a single point P_{load}. Such a point can for example correspond to the position of the center of the battery 400 of the mobile robot 20, when the mobile robot 20 is positioned in the battery load/unload position 115. Sensing the guiding elements 105, the mobile robot 20 can try to position itself at point P_{load}. This method of positioning by the guiding elements 105 comes with an error which can be distributed in the range 0 to d_{MAX}. Thus, in the worst case, the robot 20 can be positioned in the point P_{load}±d_{MAX}. In a preferred embodiment, the grabber element 350 (see FIG. 4A, 4B, 4C), may tolerate an error not larger than e_{MAX}, such as for example e_{MAX}=10 mm. On the other hand, d_{MAX} may reach values of at least 1 cm in some circumstances. Thus, for a robust device, extra localization elements 343 can be required to deal with the said worst case or any cases where d_{MAX}≥e_{MAX}.

Having localized the position of the battery 400 of the mobile robot 20, station 10 can calculate the misalignment of the battery 400. That is, station 10 can calculate the offset of the current position of the battery 400, from the perfectly aligned position.

Based on the mechanics and the configuration of station 10, it can comprise a tolerable misalignment. If the misalignment of the battery 400, is smaller than the tolerable misalignment, than station 10, particularly the grabber element 350, can grab the battery 400. If the misalignment of the battery 400, is bigger than the tolerable misalignment, than the grabber element 350 cannot grab the battery 400.

In a next step 911, station 10 compares the misalignment of the battery 400 with the tolerable misalignment. If the misalignment is bigger than the tolerable misalignment, the station 10 can report an error 913 to an operator, or to the server 90. The mobile robot 20 can proceed by making a decision 915 to abort or not the battery swapping process. In an embodiment, such a decision can be influenced by the type of error 913 that occurred. In another embodiment, the mobile robot 20 is configured to always abort the battery swapping process. In another embodiment, the mobile robot 20 is configured to always not abort the battery swapping process. In yet another embodiment, the mobile robot 20 is configured to make such a decision 915 by running a specific algorithm In yet another embodiment, the decision 913 is made by the operator or by the server 90 and is communicated to the mobile robot 20. In case the decision 913 is made to abort the battery swapping process the mobile robot 20 proceeds to step 917 and aborts the battery swapping process. If the decision 913 is made to not abort the battery swapping process, then the mobile robot 20 proceeds to step 919 wherein the mobile robot 20 can leave the battery station 10 and loops back to step 905. Step 905 is followed by step 907, 909, 911 and so on as described in the preceding paragraphs and in the flowchart of FIG. 6.

However, in some instances, in step 919, the mobile robot may not leave the battery station 10, but may correct or try to correct its position, and the method can loop back to step 907 instead. That is, while in FIG. 6 the method comprises the mobile robot 10 leaving the battery station in step 919 after it is decided to abort the battery swapping process, and re-approach the battery station in step 905 (i.e. restart the battery swapping process), in some instances (not shown in FIG. 6), the method can comprise, in step 919, the mobile robot 10 correcting its position and the method continuing from step 919 to step 907.

Put differently, step 919 can comprise the mobile robot leave the battery station or the mobile robot correct its positioning on the battery station. Correcting the positioning can comprise performing relatively small translational and/or rotational movements. Step 919 can be followed by step 905 when the mobile robot leaves the battery station in step 919. Step 919 can be followed by step 907 when the mobile robot corrects its position instead of leaving the battery station in step 919. If the misalignment is smaller than the tolerable misalignment, in a next step 921 the battery station 10 can swap the battery 400 of the mobile robot 20. The grabber 350 can grab the discharged battery 400 from the mobile robot 20. It can accomplish this by first releasing the latches 610 (refer to FIG. 3A) that keep the battery 400 fixed to the robot battery holder 602 of the robot 20 and then it can use its grabbing grippers 355 to fix the battery 400 to its body. Then, the at least one controller unit of the station 10 can check the charging units 132 to find the unoccupied ones and then based on a specific algorithm it can decide which of the unoccupied charging units 132 to choose. The at least one controller can then provide the coordinates of the chosen unoccupied charging unit 132 to the handling mechanism 300. The handling mechanism 300 can position the grabber 350, loaded with the discharged battery 400, to the coordinates supplied by the controller unit, which refer to the free charging unit 132. The grabber 350, can attach the battery 400 to the latches 610 of the station battery holder 600 of the charging unit 132 and then release the battery 400. The battery 400 can stay attached to the station battery holder 600 of the charging unit 132 by means of latches 610. The controller can initiate the charging process in the charging unit 132 and also based on specific algorithms can find a charging unit 132 containing a charged battery 400 and provide its coordinates to the handling mechanism 300. A charged battery 400 can be any battery 400 with an energy level from fully charged to not empty. The handling mechanism 300 can take the charged battery 400, use the localization elements 343 to find the position of the robot battery holder 602 of the mobile robot 20, and load the charged battery 400 into the robot 20. The robot 20 can now continue performing its tasks with a charged battery 400.

FIG. 7A shows one exemplary embodiment of a mobile robot 20 being served by the station 10. The mobile robot 20 may be an electric vehicle, autonomous, semi-autonomous or non-autonomous mobile robot 20. In the embodiment of FIG. 7A, the mobile robot 20 can be a delivery robot 20. The mobile robot 20 can be adapted to deliver items to recipients. Said items can comprise packages, mail online and in-store purchases, grocery, meals, take-out, beverages, flowers and/or other items that can be desirable to have delivered. The robot 20 may comprise a robot frame 802 and wheels 806 mounted to the robot frame 802. In the depicted embodiment, there are provided a total of 6 wheels 806. The robot 20 also comprises a body or housing 810 comprising a compartment adapted to house or store the items to be delivered to the addressee or the delivery recipient (not shown). This compartment may also be called a delivery or item compartment. The body 810 may be mounted on the robot frame 802. The robot 20 also typically comprises a lid 814, also referred to as a cover, adapted to close the body or housing 810. That is, the cover 814 may assume a closed position depicted in FIG. 7A and an open position. In the closed position, there can be no access to the items in the delivery compartment of the body 810. In the open position of the cover 814 (not depicted), the delivery recipient may reach into delivery compartment of the body 810 and obtain the items from the inside of the body 810. The robot 20 may switch from the closed position to the open position in response to the addressee performing an opening procedure, such as the addressee entering a code or the addressee otherwise indicating that he/she is in a position to obtain the goods from the robot 20. For example, the addressee may access the delivery compartment by using a smartphone application or the lid 814 may be automatically opened once the delivery location can be reached by the robot 20. The robot 20 may also comprise one or a plurality of sensors 812, e.g., cameras, to obtain information about the surroundings of the robot 20. Further the plurality of sensors 812 comprise at least one optical sensor 812. The robot 20 may also comprise lights 808, such as LEDs 808. Furthermore, in the depicted embodiment, the robot 20 includes a signaling device 816, which may extend upwards.

Typical dimensions of the robot 20 may be as follows. Width: 20 to 100 cm, preferably 40 to 70 cm, such as about 55 cm. Height (excluding the signaling device 816): 20 to 100 cm, preferably 40 to 70 cm, such as about 60 cm. Length: 30 to 120 cm, preferably 50 to 80 cm, such as about 65 cm. The weight of the robot 20 including the transported items may be in the range of 2 to 50 kg, preferably in 5 to 40 kg, more preferably 7 to 25 kg, such as 10 to 20 kg. The signaling 816 may extend to an overall height of between 100 and 250 cm, preferably between 110 and 200 cm, such as between 120 and 170 cm. Such a height may be particularly advantageous such that the signaling device 816 and thus the overall robot 20 can be easily seen by other traffic participants.

The robot 20 can assume requirement for service from station 10, when its battery 400 is discharged below a threshold level. Such a threshold level can be chosen based on the maximum time that is required for the robot 20 to rich the nearest station 10 from a point in its operation zone. For example, the robot 20 may operate in a certain area S comprising at least one station 10. In area S there exist at least one point d, for which a robot 20 positioned in point d requires energy to reach to the base station 10. In a worst-case scenario, the discharged threshold level of the battery 400 would be at least the energy that the robot 20 needs to travel from point d to station 10. In another scenario, the threshold may be the mean energy that the robot 20 needs to reach station 10 from different points of operation zone S. Threshold level may be programmed in the robot 20 and/or may be chosen by the operator of the system.

To detect whether the battery 400 of the mobile robot 20 has reached the threshold level, the mobile robot 20 needs to measure the voltage of the energy level of the battery periodically. The robot 20 can accomplish this by directly measuring the voltage of the battery 400 through the electrical pins 420 that electrically connect the battery 400 to the robot 20. However, this method of measuring the voltage of the battery 400 cannot be very robust. Since robot 20, preferably can be a mobile robot 20, it would constantly be in move. The movements of robot 20 can cause vibrations of battery 400, and thus vibrations of electrical pins 420. Due to these vibrations, the resistance between the electrical pins 420 and the contact points of the robot battery holder 602 of robot 20 changes, causing false measurements of the voltage of battery 400 of robot 20. Furthermore, the vibrations of electrical pins 420 can generate electromagnetic noise which can interfere the measurements of the voltage of the battery 400 through the electrical pins 420.

To overcome these problems related to battery voltage measurements in a mobile robot 20, in a preferred embodiment the battery 400 can be adapted to transmit energy level information to the robot 20. In a preferred embodiment, the battery 400 can comprise a battery status transmitter 426, such as an IR sensor 426. The IR sensor 426, can be adapted to transmit data related to its energy level, in the IR frequency band. The robot 20 can be adapted to receive the data sent by the IR sensors 426 of the battery 400 in the IR frequency band, i.e. the robot 20 can comprise a second IR sensor (not shown). The IR frequency band includes carries with a frequency in the range 300 GHz to 430 THz. Such frequencies clearly cannot be produced by the normal vibration of battery 400 produced while mobile robot 20 moves. Thus, the interference between the electromagnetic waves produced by the vibration of battery 400 and the IR band communication between battery 400 and robot 20 can be avoided. The IR sensors 426 of battery 400 can be programmed to periodically transmit the energy level of battery 400 to robot 20. Thus robot 20 can be continuously updated with precise data related to battery 400 level. Based on this data the robot 20 can decide if the battery 400 has reached the threshold level or not.

In FIG. 7A, the robot 20 can be positioned so as to be serviced via station 10. Thus, robot 20 can be positioned in the battery load/unload position 115. The robot 20 can drive to the top of station 10 by climbing the ramp 103 of station 10. The robot 20 can comprise a plurality of optical sensors 812 adapted to sense the horizontal lines 105 of station 10. Robot 20 can be programmed to stop after the optical sensors 812 cannot sense the horizontal lines 105. The robot 20 can align itself, using guiding elements 105, to the battery load/unload position 115.

The mobile robot 20 can comprise a robot battery holder 602 positioned in the base of the robot 20. The robot 20 can further comprise a battery 400 attached to the robot battery holder 602. The robot battery holder 602 can be adapted such that the battery 400 can be directly accessed from the base of the robot 20.

Station 10 can be adapted to access (i.e. load and/or unload) the battery of a mobile robot 20 positioned in its battery load/unload position 115. The battery load/unload position 115 is a battery load and/or unload position 115. The battery load/unload position 115 in the station 10, can be adapted such that the battery 400 of the robot 20 and the surface opening 109 can be aligned within some range of error ε. Station 10 can be adapted to overcome the misalignment ε, by using localization elements 343, and accessing the battery 400. Station 10 can be adapted to unload the battery 400 from the robot 20 and putting the battery in a charging unit 132 for charging. The station 10 can monitor the level of charge of battery 400 in the charging unit 132. Station 10 can be adapted to load a charged battery 400 in robot 20. Station 10 may indicate to the robot 20 that the battery swapping procedure is completed. Robot 20 can be adapted to receive such a message from station 10. Robot 20 can be adapted to descent from station 10 when the battery swapping process has completed.

Referring now to FIG. 7B, a system comprising a station 10 integrated in the floor 801 of a hub 80 is shown. The hub 80 may be a building 80 comprising at least one station 10, preferably a plurality of stations 10, and/or a mobile vehicle 80, comprising at least one station 10, preferably a plurality of stations 10. In some preferred embodiments, the hub 80 can comprise a warehouse and/or a micro warehouse. In other embodiments, the hub 80 can comprise part of a shop and/or a business reserved for servicing mobile robots 20. In yet other embodiments, the hub 80 can comprise a storage container such a standard transportation container that can be referred to as a hub 80 for mobile robots 20. Such a hub 80 can then serve to service, maintain, load with items to deliver and/or store one or more robots 20. In other embodiments, the hub 80 can comprise a vehicle such as a truck that can itself move around, and serve as a hub 80 for one or more mobile robots 20.

The floor 801 of such hub 80 comprises at least one hub floor opening 803 adapted to expose the top of the station 10, comprising the identification element 107, the surface opening 109 and the horizontal lines 105 of the station 10. In the system depicted in FIG. 7B the robot 20 does not need to comprise means of climbing the station 10. In the system depicted in FIG. 7B the station 10 does not need to comprise the ramp 103. This implementation of a system comprising at least one mobile robot 20 and at least one station 10 integrated in the floor 801 of the hub 80, results in a more practical implementation, by preserving space and by simplifying the process of battery swapping since the means for climbing and descending the station 10 are required. Further, in another embodiment of such a system, the battery load/unload position 115 may also be integrated in the floor 801 of the hub 80. This embodiment can further simplify the station 10, since the means for supporting the weight of robot 20 are not required for station 10. Since the battery load/unload position 115 can be integrated in the floor 801 of hub 80, robot 20 will not weight in the station 10 in any phase of the battery swapping process, but instead will be weighting on the floor 801. The floor 801 can be already adapted to support the weight of robot 20. In another embodiment of such a system a floor lid (not shown) can be integrated in the floor 801 of hub 80, in the positions where stations 10 can be located. The floor lid can assume a closed position and an open position. In a closed position the floor lid lies horizontally on the floor 801. In an open position the floor lid can allow an operator to access the station 10 in case of possible system hazards.

Referring now to FIG. 7C, an embodiment of a system comprising at least one mobile robot 20, at least one station 10 and at least one server 90 is shown. The mobile robot 20, station 10 and server 90 can be adapted to comprise communication means between each other. The server 90 can monitor the operation of mobile robot 20 and station 10. The server 90 may also assume control of the operation of robot 20 and station 10. Server 90 can comprise knowledge of the operation of robot 20 and station 10 such as: positions of robot 20 and station 10, battery level of battery 400 of robot 20, battery levels positioned in the charging units 132 of station 10, status of charging units 132 of station 10 if they can be free or not etc. In such an embodiment, the server 90 can communicate to robot 20 information related to the stations 10 comprised by the system, said information including: ID of nearest station 10, ID of the nearest station 10 that comprise free charging units 132, status of the chosen station 10 whether it is being used by another robot 20 or not, distance to the chosen station 10, directions to reach the chosen station 10, when to start the battery swapping procedure, when the battery charging procedure is completed etc. The robot 20 can read the identification element 107 of station 10, and can communicate to the station 10 ID to the server 90, indicating that station with that ID is being used by it. Station 10 may communicate to server 90 the status of the process of battery swapping procedure indicating when the procedure is completed. Station 10 can communicate to server 90 the status of its charging units 132, the charging level of the batteries contained in the charging units 132 etc. Thus server 90 can manage the operation of such a system by means of communication between server 90, robot 20 and station 10.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

We claim:

1. A flexural joint, for use in a battery station, comprising:
(a) a first group of rigid members configured to mount a first group of elements to the flexural joint;
(b) a second group of rigid members configured to mount a second group of elements to the flexural joint;
(c) a third group of elastic members configured to provide flexibility;
(d) a first flexural mechanism configured to allow rotational motion of at least one of the first group of rigid members with respect to the second group of rigid members and the second group of rigid members with respect to the first group of rigid members; and
(e) a second flexural mechanism configured to allow linear motion of at least one of the first group of rigid members with respect to the second group of rigid members and second group of rigid members with respect to the first group of rigid members.

2. The flexural joint of claim 1, wherein the flexural joint is configured to allow motion with at least two degrees of freedom wherein
(a) a first degree of freedom allows rotational motion of at least one of:
(i) the first group of rigid members with respect to the second group of rigid members; and/or
(ii) the second group of rigid members with respect to the first group of rigid members, and
(b) a second degree of freedom allows linear motion of at least one of:
(i) the first group of rigid members with respect to the second group of rigid members in a direction perpendicular to an axis connecting the first group of rigid members and the second group of rigid members; and/or
(ii) the second group of rigid members with respect to the first group of rigid members in a direction perpendicular to an axis connecting the first group of rigid members and the second group of rigid members.

3. The flexural joint of claim 2, wherein the motion with at least two degrees of freedom is facilitated by thin elastic members of the flexural joint that bend at predefined distances and/or along predictable trajectories.

4. The flexural joint of claim 2, wherein the flexural joint comprises a higher stiffness in the degrees of freedom other than the at least two degrees of freedom intended to provide flexibility according to claim 2.

5. The flexural joint of claim 1, wherein the flexural joint is monolithic and comprises a plastic material.

6. The flexural joint of claim 5, wherein the flexural joint is manufactured by at least one of 3D printing technology, injection molding, and extrusion.

7. The flexural joint of claim 2, wherein at least one of the first group of rigid members and the second group of rigid members of the flexural joint is thicker than the third group of elastic members of the flexural joint, configured to provide at least one of flexibility with at least 2 degrees of freedom and high stiffness in all other degrees of freedom except the at least 2 degrees of freedom intended to provide flexibility.

8. The flexural joint of claim 1, wherein the first flexural mechanism comprises a mounting base connected with a top surface by two elastic elongated elements with each of the elastic elongated elements having one end attached to the top surface and the other end attached to the mounting base, and wherein the two elastic elongated elements are intersected at a pivot point, forming an “X”-like structure.

9. The flexural joint of claim 1, wherein the first flexural mechanism is configured to provide rotation flexibility of 0.2 to 15 degrees clockwise and/or counterclockwise from the equilibrium.

10. The flexural joint of claim 1, wherein the first flexural mechanism is configured as a cartwheel hinge.

11. The flexural joint of claim 1, wherein the second flexural mechanism comprises a first mounting side connected with a second mounting side by at least one of a first elastic arm and a second elastic arm, wherein the first elastic arm and/or the second elastic arm are attached on one end to the first mounting side and on the other end to the second mounting side.

12. The flexural joint of claim 1, wherein the second flexural mechanism is configured to provide linear flexibility of 0.5 to 15 mm up and/or down from the equilibrium.

13. The flexural joint of claim 1, wherein the second flexural mechanism is configured as a parallelogram flexure.

14. A system for swapping a battery, comprising:
(a) at least one flexural joint according to claims 1; and
(b) a battery station configured to swap the battery.

15. The system of claim 14, wherein the at least one flexural joint is configured to increase tolerable misalignment for grabbing the battery, between the battery station and the battery, said tolerable misalignment comprising at least one of the following:
(a) the maximum incorrect positioning of the battery relative to the battery station such that the battery station is able to grab the battery; and/or
(b) the maximum incorrect positioning of the battery station relative to the battery such that the battery station is able to grab the battery.

16. The system of claim 14, wherein the battery station comprises a battery grabber element adapted to grab a battery and wherein the battery grabber element comprises a plurality of grippers attached to the battery grabber element using at least one flexural joint.

17. The system of claim 16, wherein the flexural joint comprises:
(a) a first group of rigid members, configured to mount the flexural joint on the battery grabber element, comprising at least one of the following elements:
(i) a mounting base, and/or
(ii) a top surface; and
(b) a second group of rigid members, configured to mount the grippers to the flexural joint, comprising at least one of the following elements:
(i) a first mounting side, and/or
(ii) a second mounting side.

18. The system of claim 14, wherein the flexural joint is adapted to increase tolerance of the battery station by at least 5 mm by providing flexibility to the system.

19. The system of claim 18,
wherein the battery station comprises a battery grabber element adapted to grab the battery and wherein the battery grabber element comprises a plurality of grippers attached to the battery grabber element using at least one flexural joint, and
wherein the grippers are configured to grip the battery at least with the tolerance provided by the flexural joint.
